(19) United States
(12) Patent Application Publication
(10) Pub. No.: US 2026/0288706 A1
(43) Pub. Date: Sep. 24, 2026

(54) SYSTEM

(71) Applicant: SoftBank Group Corp., Tokyo (JP)

(72) Inventor: Hiroki KATO, Tokyo (JP)

(73) Assignee: SoftBank Group Corp., Tokyo (JP)

(21) Appl. No.: 19/566,999

(22) Filed: Mar. 14, 2026

(30) Foreign Application Priority Data
Mar. 19, 2025 (JP) 2025-045006

(51) Int. Cl. G06F 16/242; G06F 16/22; G06F 16/28; G06F 40/205; G06F 40/284; G06F 40/30; G06F 40/40

(52) U.S. Cl. CPC G06F 16/243; G06F 16/2237; G06F 16/285; G06F 40/205; G06F 40/284; G06F 40/30; G06F 40/40

(57) ABSTRACT

A system includes a processor that is configured to aggregate, into a database, information of individual users and job descriptions of departments, analyze a specific request of a user by using natural language processing techniques and generate a prompt for instructing a search for a related person from the database, and analyze an emotion of the user based on sensor data or input information of the user and feed back an analysis result to a generative AI model.

### CROSS-REFERENCE TO RELATED APPLICATION

This application is based on and claims priority under 35 USC 119 from Japanese Patent Application No. 2025-045006 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems that support internal communication, personnel search, and department matching in an organization typically rely on simple keyword-based search or static profile matching. Such systems do not sufficiently understand the user's natural-language intent, and therefore often fail to identify persons or departments that are truly relevant to the user's situation or needs. In addition, conventional systems generally do not take into account the emotional state of the user, even though emotion can significantly influence what kind of support, recommendation, or connection is appropriate at a given time. As a result, users may experience difficulty in discovering suitable colleagues who share appropriate expertise, hobbies, or interests, or in identifying departments in which they wish to perform work, leading to reduced satisfaction and inefficient internal collaboration. There is therefore a need for a system that can (i) aggregate user information and department job descriptions in a database, (ii) accurately analyze user requests expressed in natural language to generate effective prompts for searching related persons or departments, and (iii) analyze the user's emotional state based on sensor data or user input information and feed back the analysis result to a generative AI model, so that search and recommendation results can be dynamically adapted to the user's emotional context.

### SUMMARY

In order to solve the above-described problems, the present invention provides a system comprising a processor, wherein the processor is configured to aggregate, into a database, information of individual users and job descriptions of departments, analyze a specific request of a user by using natural language processing techniques and generate a prompt for instructing a search for a related person from the database, and analyze an emotion of the user based on sensor data or input information of the user and feed back an analysis result to a generative AI model. In one aspect, the processor is configured to generate, based on the user's request, a prompt for instructing a search from the database for a department in which the user desires to perform work, thereby enabling more accurate department recommendations that reflect both the user's skills and expressed intent. In another aspect, the processor is configured to analyze an emotional state of the user and, based on the analysis result, generate a prompt for instructing a search from the database for a person who shares a specific hobby or interest, thereby allowing the generative AI model to adapt search and recommendation behavior to the user's current emotional condition and to propose more appropriate interpersonal connections. Through these means, the system improves the precision and contextual relevance of internal searches and recommendations for persons and departments.

The term “processor” refers to any hardware component or combination of hardware components, including but not limited to a central processing unit (CPU), microprocessor, microcontroller, graphics processing unit (GPU), or dedicated accelerator, that executes instructions to perform the functions described in the present disclosure.

The term “database” refers to any structured or semi-structured data storage system, including relational databases, NoSQL databases, graph databases, or other data repositories, that stores and manages information of individual users and job descriptions of departments for retrieval and processing by the processor.

The term “information of individual users” refers to data items associated with each user, including, for example, user identity, organizational affiliation, expertise, skills, work experience, hobbies, interests, sensor-derived data, and other profile information that can be stored in the database.

The term “job descriptions of departments” refers to information representing the roles, responsibilities, tasks, required skills, missions, and operational characteristics of organizational departments, stored in the database for use in searching and matching processes.

The term “natural language processing techniques” refers to algorithms, models, and computational methods that enable the processor to analyze, interpret, and process text or speech expressed in human languages, such as tokenization, part-of-speech tagging, parsing, intent detection, semantic analysis, and related techniques.

The term “specific request of a user” refers to a query, demand, or expression of need provided by the user in natural language, such as a request to find related persons, to search for departments in which the user wishes to work, or to discover colleagues sharing particular attributes.

The term “prompt” refers to data, typically text or structured text, generated by the processor and supplied as input to a search process or to a generative AI model, the data specifying instructions or conditions for searching a database or generating responses.

The term “related person” refers to a person identified as relevant to a user's request based on one or more criteria, including but not limited to similar skills, expertise, job roles, hobbies, interests, organizational affiliation, or emotional compatibility.

The term “sensor data” refers to information acquired from one or more sensors associated with the user, including, for example, biometric sensors, wearable devices, cameras, microphones, or environmental sensors, that can be used to infer or estimate an emotional state of the user.

The term “input information of the user” refers to data explicitly entered or provided by the user through an interface, such as text input, questionnaire responses, feedback indicators, or other interaction signals, which can be used to determine or estimate the user's emotional state.

The term “emotion of the user” refers to an affective state or emotional condition of the user, such as stress, satisfaction, frustration, excitement, or calmness, inferred from sensor data, input information, or combinations thereof.

The term “analysis result” refers to output data produced by the processor based on processing of sensor data and/or input information of the user, the data representing an estimated emotional state or other interpreted condition of the user.

The term “generative AI model” refers to a machine learning model, such as a large language model or other generative model, that generates text, prompts, recommendations, or other content based on input data including the analysis result, user information, and database contents.

The term “department in which the user desires to perform work” refers to an organizational unit or division identified as a potential or preferred workplace for the user based on the user's request, skills, interests, or other profile information.

The term “emotional state of the user” refers to a state of the user's emotions derived by the processor from sensor data or input information, including qualitative categories, quantitative scores, or other representations suitable for influencing search or recommendation behavior.

The term “person who shares a specific hobby or interest” refers to an individual stored in the database whose profile information includes a hobby or interest that corresponds to a specified hobby or interest associated with the user or determined from the user's emotional state or request.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

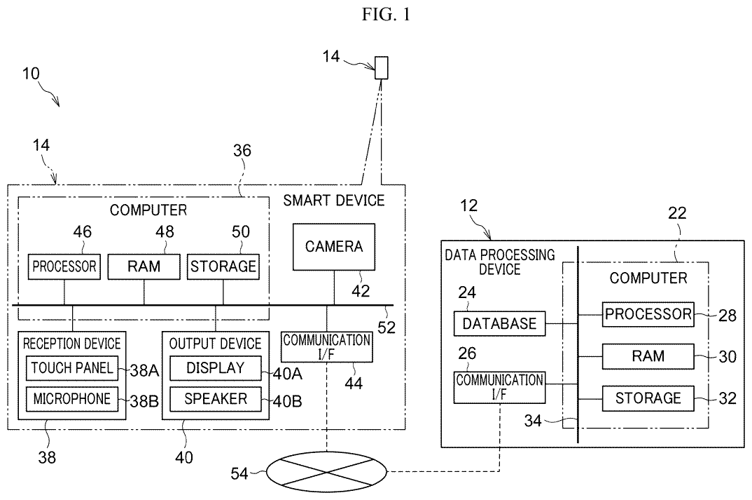

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

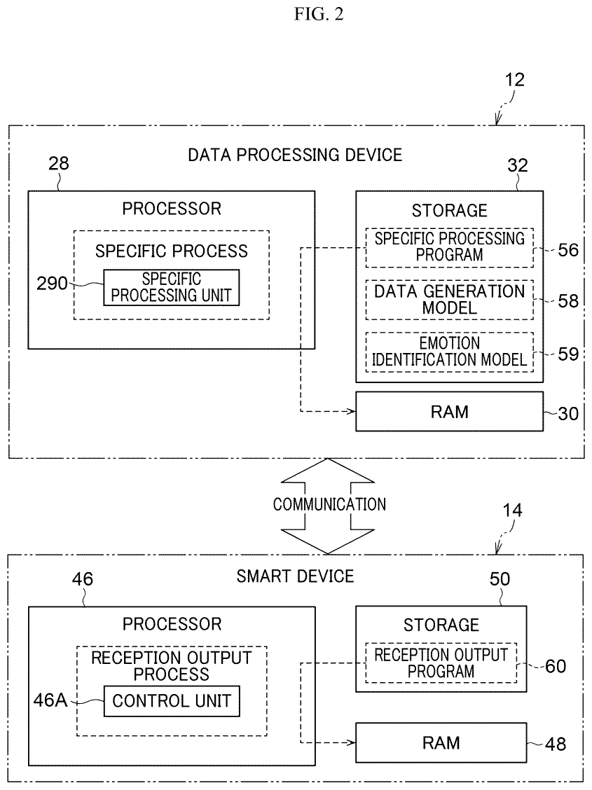

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional recommendation and assignment systems in organizational environments typically rely on static rule-based matching between user profiles and organizational roles. In many cases, such systems simply compare a small set of structured attributes, such as job title or predefined skill tags, against fixed requirement lists stored in a database. As a result, these systems are unable to effectively leverage richer, dynamically changing user information, such as detailed expertise, nuanced interests, fine-grained preferences, and evolving emotional states, when generating assignment suggestions or career recommendations.

Furthermore, in existing systems, any natural language content used for recommendations is often generated by predefined templates, which do not reflect the full context of the user's profile or the current organizational landscape. Those systems rarely integrate large-scale generative AI models in a way that is technically coordinated with database-level matching logic. In particular, typical architectures do not structure the interaction with a generative AI model through systematically constructed prompt sentences that incorporate database query results, user behavior history, and emotional state estimation as machine-consumable input. Consequently, the generated recommendations tend to be generic, repetitive, and insufficiently tailored to the user's actual situation, limiting their effectiveness.

From the perspective of computer technology, such limitations manifest as inefficient utilization of storage and computation resources, because the underlying databases and processing pipelines are not designed to coordinate structured query processing with adaptive natural language generation. Existing systems often perform user matching and content generation as separate, loosely coupled modules, which leads to redundant data access, duplicated processing, and increased latency. Additionally, the lack of feedback from user interaction history and emotional state to the prompt generation process prevents the system from improving its behavior over time, resulting in a static and suboptimal recommendation engine.

Therefore, there is a need for a computer-implemented system and method that: (i) systematically aggregates and maintains user attribute information and organizational work content information in a relational database; (ii) executes query-language-based matching to identify suitable organizational or work candidates for each user; (iii) constructs prompt sentences that explicitly encode the matching results, the user's interests, preferences, and emotional state; and (iv) uses those prompt sentences as input to a generative AI model to generate highly contextual proposal sentences. By tightly integrating database query processing, prompt generation, and generative AI models, the system should improve the technical performance of the recommendation pipeline, including efficiency, scalability, adaptability, and the relevance of machine-generated outputs.

The specific processing by the specific processing unit 290 of the data processing device 12 in Example 1 is realized by the following means.

The present invention provides a server comprising a processor configured to collect and store, in a relational database managed by the server, attribute information of individual users and work content information of organizations, to execute query processing using a query language on the relational database so as to identify, based on specialty information, skill information, interest information, preference information, and operation history information of each user and required skill information and work content information of each organization, one or more organization candidates or work candidates suitable for the user, to generate a prompt sentence including at least the interest information and the preference information of the user and information regarding the identified organization candidates or work candidates, to input the prompt sentence to a generative AI model so as to cause the generative AI model to generate a proposal sentence related to the interest information and the preference information of the user, to store, in association, the proposal sentence and the identified organization candidates or work candidates in a storage resource, to present the proposal sentence and the identified organization candidates or work candidates to a terminal used by the user, to acquire operation history information or response information from the terminal, and to update at least one of generation conditions of the prompt sentence and identification conditions of the organization candidates or work candidates based on the operation history information or the response information. This enables an integrated computer-implemented recommendation architecture in which structured database matching and adaptive prompt-based interaction with a generative AI model are technically coordinated, thereby improving computational efficiency, reducing redundant processing, and enhancing the contextual relevance and personalization quality of machine-generated proposal sentences from the perspective of computer system performance.

The term “user” refers to an individual person for whom attribute information, such as specialty information, skill information, interest information, and preference information, is stored and processed by the system.

The term “attribute information” refers to information describing characteristics of a user, including at least specialty information, skill information, interest information, preference information, and optionally operation history information or emotional state information.

The term “specialty information” refers to information indicating technical fields, academic fields, or professional domains in which a user has expertise or specialization.

The term “skill information” refers to information indicating capabilities or competencies of a user, such as abilities to perform specific tasks, use particular tools, or apply certain methods.

The term “interest information” refers to information indicating topics, fields, or activities in which a user has a sustained curiosity, motivation, or desire to engage.

The term “preference information” refers to information indicating choices, inclinations, or favored conditions of a user, including preferred work styles, project types, or content characteristics.

The term “operation history information” refers to information indicating past interactions of a user with the system, including selections, inputs, clicks, confirmations, rejections, or other actions performed via a terminal.

The term “response information” refers to information indicating explicit feedback or reactions from a user to presented content, including evaluations, comments, confirmations, refusals, or modifications of proposals.

The term “organization” refers to an entity that performs one or more types of work, including at least departments, divisions, project teams, or other organizational units.

The term “work content information” refers to information describing tasks, responsibilities, or activities carried out by an organization, a department, or a work unit, including required skills and objectives.

The term “required skill information” refers to information specifying abilities, competencies, or knowledge that are needed or preferred for performing particular work content in an organization.

The term “organization candidate” refers to an organization, department, or other organizational unit that is identified as suitable for a user based on matching between user attribute information and organizational work content information.

The term “work candidate” refers to a specific task, project, role, or work unit that is identified as suitable for a user based on matching between user attribute information and work content information.

The term “relational database” refers to a data storage system that stores data in tables with rows and columns and supports query processing using a structured query language or an equivalent query mechanism.

The term “query language” refers to a formal language used to retrieve, insert, update, or delete data stored in a database, including at least structured query language or an equivalent data manipulation language.

The term “prompt sentence” refers to a machine-readable natural language string that is constructed by the processor to describe user attribute information, organization candidates, work candidates, or contextual conditions, and that is provided as input to a generative AI model.

The term “generative AI model” refers to a trained computational model that, in response to a prompt sentence, generates natural language text or other content by predicting output tokens based on learned parameters.

The term “proposal sentence” refers to a natural language text generated by the generative AI model in response to a prompt sentence, the text including at least recommendations, suggestions, or guidance related to a user's interests, preferences, or suitable organizations or work candidates.

The term “generation conditions of the prompt sentence” refers to parameters, rules, or templates that control how a prompt sentence is constructed, including which user attributes and matching results are included and how they are expressed.

The term “identification conditions of the organization candidates or work candidates” refers to criteria, thresholds, or weighting rules used in query processing and matching to determine which organizations or work units are selected as candidates for a user.

The term “emotional state” refers to an estimated state of a user's emotion, mood, or affect, inferred from attribute information, operation history information, or other input data.

The term “terminal” refers to an information processing device operated by a user, including at least a personal computer, a mobile device, or an equivalent client device capable of communicating with the server.

In one embodiment, a server, a terminal, and a user cooperate to implement the invention. The server includes at least one processor, a main memory, a non-volatile storage device, and a network interface. The terminal includes a processor, a display device, an input device, a memory, and a communication interface. The server and the terminal are connected via a communication network such as the Internet or an intranet, using communication protocols such as HTTP over TLS.

The server uses an operating system, such as a general-purpose server operating system, and a database management system, such as a relational database engine implementing SQL. The server further uses an application execution environment, such as an application framework for web applications or microservices, and a generative AI model hosted on an accelerator-based computation environment, such as a computing cluster including one or more graphics processing units or tensor processing units.

The server stores user attribute information and organizational work content information in a relational database. The server defines a data schema including, for example, a user table, a skill table, an interest table, an organization table, a work table, and a recommendation table. The server stores user identifiers, specialty information, skill information, interest information, preference information, and operation history information in normalized relational structures, and stores work content information and required skill information in separate but related tables. The server uses primary keys, foreign keys, and indexing structures, such as B-tree or hash indexes, to accelerate query processing.

The server uses a database management system such as a relational engine compatible with structured query language to perform query processing. The server executes join operations, filtering operations, grouping operations, and sorting operations in the database engine, in order to identify organization candidates or work candidates that match a user. The server optimizes query plans by using statistics, indexes, and prepared statements, which reduces I/O overhead and improves cache utilization. The server thus improves computational efficiency compared to naive record scanning or unindexed lookup.

The server uses a generative AI model implemented as a neural network-based language model. In one embodiment, the generative AI model is a transformer-based neural network including an input embedding layer, a plurality of self-attention layers, feed-forward layers, and an output projection layer. The server stores model parameters, such as weight matrices and bias vectors, in a model storage. The server applies the generative AI model to a prompt sentence by performing a sequence of matrix multiplications, non-linear activation functions, and attention computations. During training of the generative AI model, the server or an external training system uses a loss function such as cross-entropy loss between predicted token distributions and ground-truth tokens, and optimizes model parameters using gradient-based optimization, such as stochastic gradient descent or an adaptive optimization algorithm. The training process includes forward propagation, backpropagation of error gradients, and weight updates based on mini-batches of text data. The training process optionally uses data augmentation techniques, such as random masking or token permutation within constraints, to improve generalization.

The server defines a set of features used as input signals for the generative AI model. The server uses tokenized representations of the prompt sentence, where the prompt sentence includes tokens representing user skill information, interest information, preference information, and information regarding the identified organization candidates or work candidates. The server uses a tokenizer to convert text into token identifiers according to a vocabulary used by the generative AI model. The server may incorporate additional control tokens or tags in the prompt sentence to guide the generative AI model, such as tokens indicating required style, length, or focus topics. The server thus uses a structured encoding of database-derived information into the prompt sentence, rather than relying on unstructured or manual text.

The server constructs the prompt sentence by combining results obtained from the relational database with the attribute information and operation history information of the user. The server uses program logic to insert user-specific values and candidate-specific values into a prompt template. For example, the server generates a prompt sentence such as:

“The user has skills in Python and data analysis. The user is interested in machine learning and enjoys reading research papers and implementing algorithms. The user is a strong candidate for projects A and B in the data analytics organization. Please generate a personalized proposal that suggests concrete learning resources, recent machine learning topics, and suitable internal projects for this user.”

In another example, the server generates a prompt sentence such as:

“The user has skills in UI design and prototyping tools. The user is highly interested in user experience and enjoys usability testing. The user is a strong candidate for UX improvement projects in the product development organization. Please generate a proposal sentence that recommends relevant UX projects, practical improvement activities, and learning resources for advanced UX design.”

The server may additionally incorporate estimated emotional state into the prompt sentence. For example, the server generates a prompt sentence such as:

“The user recently rejected several high-pressure projects and selected low-intensity training activities. The user appears to be in a fatigued emotional state. Please propose supportive and low-stress learning activities and project assignments suitable for this emotional state while respecting the user's interests in machine learning.”

The server estimates an emotional state of the user based on operation history information and attribute information. The server uses statistical features, such as frequency of acceptance or rejection of certain types of projects, time intervals between interactions, and patterns of navigation among options. The server may additionally use sensor-derived data when available, such as usage time windows or interaction duration. The server applies a classification algorithm, such as logistic regression, support vector machines, or a shallow neural network, to map the extracted features to a discrete or continuous emotional state representation. The server stores this emotional state in the relational database and updates it as new operation history information is obtained.

The server uses the estimated emotional state to adjust generation conditions of the prompt sentence. The server modifies variables such as the target length of the generated proposal sentence, the intensity of recommendations, the number of options, and the complexity of technical content. The server, for example, reduces recommendation strength and complexity when the emotional state indicates fatigue, and increases detail level and challenge level when the emotional state indicates high motivation. The server uses non-linear mappings and threshold rules encoded in the application logic to determine such modifications. The server thereby causes the generative AI model to generate proposal sentences that are not only relevant to skills and interests but also adapted to the user's current state, which cannot be easily achieved by purely rule-based templates.

The server implements a prompt generation module, a matching module, a generative AI interface module, and a feedback adaptation module as separate software components. The server uses internal data structures such as in-memory objects and data transfer objects to pass intermediate results between modules. The server uses time-stamped records of prompt sentences and generated proposal sentences stored in the recommendation table to support auditability and further optimization. The server may compute performance metrics, such as acceptance rates and engagement durations, to evaluate different variants of prompt sentence templates and matching conditions, and may adjust generation conditions accordingly in a non-conventional, feedback-driven manner.

The terminal provides a graphical user interface for the user to input attribute information and to view proposal sentences and organization candidates or work candidates. The terminal may execute a web browser or a native application. The terminal displays input forms derived from metadata received from the server, and transmits user input in structured formats to the server. The terminal displays the proposal sentence and candidates in a layout that allows the user to indicate acceptance, rejection, or modification. The terminal sends operation history information, such as button clicks and scroll actions, to the server in a structured event format. The terminal thus functions as a controlled interface for collecting precise interaction data, which is used by the server to refine its internal models and conditions.

The user uses the terminal to enter specialty information, skill information, interest information, and preference information. The user additionally provides explicit feedback on proposed organizations or work candidates, such as approvals, bookmarks, or comments. The user may also modify settings related to the level of detail or type of recommendations. The user thereby indirectly influences the operation of the prompt generation module and matching module through information captured and processed by the server.

The server, by coordinating relational database processing and generative AI model invocation, achieves technical effects beyond simple automation of manual decision-making. The server reduces redundant data transfers between modules by structuring all matching-related information in the relational database and by passing only condensed, encoded content within prompt sentences to the generative AI model. Because the server uses query optimization, indexing, and prepared statements, the server improves processing speed for large numbers of users and large organizational structures. The server also improves accuracy of matching because it uses structured joins and scoring functions that combine multiple attributes, including skills, interests, and preferences, rather than relying on single-attribute filters.

The server's adaptive prompt generation mechanism improves the quality and efficiency of generative AI processing. By including exactly those attributes and candidate descriptions that are relevant for the current user and context, and by adjusting the wording and level of detail based on emotional state and interaction history, the server reduces unnecessary token length in the prompt sentence and focuses the generative AI model's computation on salient information. This reduces computation cost on the accelerator-based environment and shortens response latency. At the same time, this focused prompt construction increases the probability that the generative AI model generates content aligned with the user's situation, which reduces the need for repeated queries or manual corrections.

The server executes non-conventional processing flows that differ from ordinary human decision-making. For example, the server applies rule sets and scoring functions for matching that operate on vectorized representations of skills and work content, and the server updates weights and thresholds based on aggregated behavior of multiple users. The server may maintain a latent space representation of skills and work content obtained by factorization or embedding techniques, and perform nearest-neighbor search in this latent space using specialized data structures such as approximate nearest neighbor indices. The server therefore performs computational matching in a manner that humans cannot replicate manually at comparable scale or speed.

In an alternative embodiment, the server uses a different architecture for the generative AI model, such as a recurrent neural network or a hybrid model, but still uses the same principle of constructing prompt sentences from database query results and user attributes. In another variation, the server hosts the generative AI model locally rather than using an external service, in which case the server directly executes the forward pass of the neural network using linear algebra libraries optimized for vectorized CPU or GPU operations. In yet another embodiment, the server uses different relational schemas or non-relational data stores, but still enforces structured mapping between attribute information, work content information, and prompt construction.

In another embodiment, the server uses multiple generative AI models for different purposes, such as one model specialized for short summaries and another model specialized for step-by-step guidance. The server selects which generative AI model to invoke based on the user's preferences, operation history information, or emotional state. The server may ensemble outputs from multiple models by applying ranking or voting mechanisms, and may store ensemble results in the recommendation table.

The server can further integrate with other technical systems, such as resource allocation systems or task scheduling systems, where the proposal sentences and candidate selections trigger downstream actions, such as configuration updates or allocation of computational resources. For example, when the generative AI model proposes that a user should join a data-intensive project, the server may coordinate with a job scheduling system to allocate additional compute resources for training tasks, thereby directly controlling machine resources based on the generated recommendations.

Because the server implements specific data structures, processing flows, and neural network interfaces, and because the server uses feedback from user interactions and emotional state estimation to refine matching and prompt generation, the system improves computer technology itself. The system achieves reduced latency of recommendation generation, higher relevance of generated proposal sentences, improved utilization of database and accelerator resources, and reduced network traffic between modules. The system thereby provides a concrete technical solution that goes beyond a mere abstract idea of recommending people to organizations or automating human judgment.

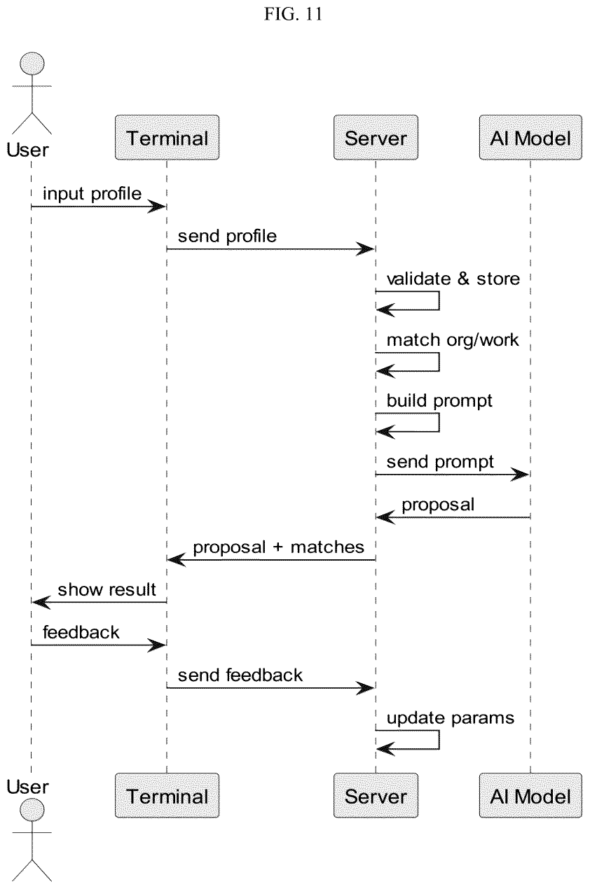

The following describes the processing flow using FIG. 11.

Step 1:

The user operates the terminal to input attribute information.

The terminal displays input fields for specialty information, skill information, interest information, and preference information.

The user enters text values, for example “Python, data analysis” as skill information and “machine learning” as interest information.

The terminal validates that required fields are not empty and that the input length is within predetermined limits.

The terminal sends a structured request containing the attribute information to the server over a network connection.

The input of this step is raw text entered by the user, and the output of this step is a structured data message transmitted from the terminal to the server.

Step 2:

The server receives the structured attribute information from the terminal.

The server parses the received message and maps each field to internal variables corresponding to user identifiers, specialty information, skill information, interest information, and preference information.

The server performs validation, such as type checking and normalization of text (for example, converting to lowercase and trimming whitespace).

The server rejects the data if mandatory fields are missing and returns an error message to the terminal; otherwise, the server accepts the data for storage.

The input of this step is the structured data message received from the terminal, and the output of this step is a validated and normalized set of attribute values stored in server memory for further processing.

Step 3:

The server stores the validated attribute information in a relational database.

The server generates database records for the user, such as inserting or updating rows in a user table, a skill table, and an interest table.

The server uses primary keys and foreign keys to maintain relationships between the user and associated skills and interests.

The server commits the database transaction to ensure persistence and consistency of the stored data.

The input of this step is the validated attribute values held in server memory, and the output of this step is a set of persistent database records representing the user's attribute information.

Step 4:

The server retrieves organizational work content information and required skill information from the relational database.

The server obtains records from organization tables and work tables, including descriptions of tasks, required skills, and organizational units.

The server may update cached indices or materialized views that summarize relationships between work content and required skills.

The input of this step is the existing organizational data stored in the database, and the output of this step is an in-memory representation of organizational work content and required skills that is ready to be compared with user attributes.

Step 5:

The server performs matching between the user's skill information, interest information, and preference information and the organizational work content information and required skill information.

The server constructs and executes database queries that join user-related tables with organization-related tables based on shared skill names or categories.

The server computes matching scores for each organization or work candidate, for example by counting overlapping skills and applying weights to different attributes.

The server sorts the candidates by matching score and selects one or more top-ranked organization candidates or work candidates.

The input of this step is the user's attribute information and the organizational work content information retrieved from the database, and the output of this step is a ranked list of organization candidates or work candidates identified as suitable for the user.

Step 6:

The server constructs a prompt sentence for a generative AI model based on the user's attributes and the identified candidates.

The server assembles text fragments describing the user's skills, interests, preferences, and the names or descriptions of organization candidates or work candidates.

The server inserts these text fragments into a predefined template to form a complete prompt sentence.

For example, the server generates a prompt sentence such as:

“The user has skills in Python and data analysis. The user is interested in machine learning and enjoys reading research papers and implementing algorithms. The user is a strong candidate for projects A and B in the data analytics organization. Please generate a personalized proposal that suggests concrete learning resources, recent machine learning topics, and suitable internal projects for this user.”

The input of this step is the internal data representing user attributes and matched candidates, and the output of this step is a textual prompt sentence formatted for input to the generative AI model.

Step 7:

The server encodes the prompt sentence for processing by the generative AI model.

The server applies a tokenizer to convert the prompt sentence into a sequence of token identifiers according to the vocabulary of the generative AI model.

The server packages the token sequence into a request structure that includes model parameters such as maximum output length and sampling temperature.

The server sends the request structure to the generative AI model execution environment via a model interface.

The input of this step is the textual prompt sentence generated in the previous step, and the output of this step is a tokenized and parameterized request delivered to the generative AI model.

Step 8:

The server causes the generative AI model to generate a proposal sentence in response to the prompt sentence.

The generative AI model processes the incoming token sequence through its neural network layers, including attention layers and feed-forward layers, and computes a probability distribution over next tokens at each generation step.

The server receives the generated token sequence from the generative AI model and decodes it into natural language text using the same tokenizer.

The server obtains a complete proposal sentence that describes recommended activities, projects, or learning paths for the user.

The input of this step is the tokenized prompt sentence and model parameters, and the output of this step is a natural language proposal sentence produced by the generative AI model.

Step 9:

The server post-processes the generated proposal sentence and associates it with the matched candidates.

The server may adjust formatting, such as inserting line breaks or bullet points, and may remove unwanted characters or truncate overly long sections.

The server stores the association between the user, the organization candidates or work candidates, and the generated proposal sentence in a recommendation table in the relational database.

The server prepares a response object containing the proposal sentence and the list of matched candidates for transmission to the terminal.

The input of this step is the raw generated proposal sentence and the previously computed list of candidates, and the output of this step is a structured response that includes cleaned proposal text and candidate information linked to the user.

Step 10:

The server sends the structured response to the terminal.

The terminal receives the response and parses the included proposal sentence and candidate list.

The terminal renders the proposal sentence on a display area and presents the matched organization candidates or work candidates with their descriptions and scores.

The user views the displayed information and can scroll or navigate through the recommended items.

The input of this step is the structured response sent from the server, and the output of this step is the visual presentation of proposal sentences and candidates on the terminal display.

Step 11:

The user interacts with the recommendations presented on the terminal.

The user performs actions such as selecting a candidate, accepting a proposal, rejecting a proposal, bookmarking an item, or requesting more details.

The terminal captures these actions as operation history events and encodes them as structured messages.

The terminal sends the operation history information back to the server over the network.

The input of this step is the user's manual interaction with the displayed UI elements, and the output of this step is a set of structured operation history records transmitted from the terminal to the server.

Step 12:

The server receives the operation history information from the terminal and updates internal data.

The server stores the operation history events in an operation history table in the relational database, associating them with the corresponding user and recommendation instances.

The server analyzes the operation history information to infer patterns, such as which types of proposals the user tends to accept or reject.

The server updates generation conditions of future prompt sentences and identification conditions of future organization candidates or work candidates, for example by adjusting weights for certain skills or changing thresholds for candidate selection.

The input of this step is the structured operation history information from the terminal, and the output of this step is updated database entries and modified matching and prompt generation parameters used to refine subsequent processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented work-assignment systems in industrial and organizational environments typically rely on fixed rules, manually defined skill matrices, or static optimization logic executed by a processor over structured data. In such systems, the processor matches user identifiers to pre-registered skill tags and associates these tags with pre-defined task templates stored in a database. This architecture suffers from several technical limitations in terms of how the computer system represents, processes, and updates complex user attributes and work-context information.

First, existing systems generally handle user capability data and work-content data as rigid, low-dimensional records (for example, simple lists of tags or numeric scores) within a relational database. When the processor attempts to select a task, it is constrained to rule-based or heuristic matching algorithms that operate only on these limited representations. As a result, the processor cannot fully exploit rich contextual information such as nuanced combinations of expertise, preferences, historical performance, and dynamic machine conditions. This leads to technically suboptimal utilization of processing resources, because the matching logic must be repeatedly reprogrammed or extended with ad hoc rules whenever new task types or user attributes are introduced.

Second, conventional systems generally do not exploit natural language generation capabilities in an integrated feedback loop between a database layer and an assignment engine. Although machine learning methods have been used in some environments, the processor typically invokes predictive models in isolation, and the resulting outputs are not expressed as natural language prompt sentences that can be iteratively refined and re-used by a generative AI model. Consequently, the system lacks a flexible mechanism for encoding multi-source data (user attributes, work content, machine mappings, performance history) into a single, expressive input format that a generative model can interpret and from which the model can generate structured task information. This limits the system's ability to generalize to previously unseen combinations of users and tasks without manual reconfiguration.

Third, existing systems usually do not establish a closed-loop architecture in which execution feedback from terminal devices and machines is automatically transformed into machine-readable history information and reincorporated into subsequent assignment computations. Progress data and completion data, when collected, are often used only for reporting, and are not systematically integrated into the core data structures that drive task selection. As a result, the processor cannot update its internal state in a way that meaningfully improves future prompt construction or generative AI outputs. This prevents the computer system from technically evolving its assignment performance over time, and forces administrators to tune parameters manually.

Fourth, many known systems separate human-readable explanations from the underlying control data, or do not generate explanations at all. In such architectures, the processor may compute a task assignment but does not generate explanation information that is tied to the assignment at the data-structure level. This undermines machine interpretability and user trust, and it also wastes an opportunity to allow the processor to handle explanation text as a first-class data object that can be displayed at the terminal while still being stored as a structured element in the database. From a computer-technology standpoint, the missing integration of explanation information with task data yields a fragmented information model and increases the complexity of the software stack.

Accordingly, there is a need for an improved computer-implemented system in which a processor: (i) aggregates user attribute information and work-content information into a unified data model; (ii) converts such structured data into a natural language prompt sentence; (iii) uses a generative AI model as a computation engine to produce structured task information; (iv) enriches that task information with equipment identification information and control parameters for real-time machine control by external terminal devices; and (v) records execution feedback as learning history information that is fed back into subsequent prompt construction and task selection. By tightly integrating a relational data management layer, prompt-based generative AI inference, and closed-loop feedback from terminal devices, the computer system can technically improve its internal data representations, its decision-making logic, and its runtime behavior, thereby enhancing the efficiency, adaptability, and scalability of the work-assignment process implemented by the processor.

The specific processing by the specific processing unit 290 of the data processing device 12 in Application Example 1 is realized by the following means.

The present invention provides a server comprising a processor and a memory storing instructions that, when executed by the processor, cause the processor to aggregate attribute information related to individual users and work-content information related to organizational units into a relational data management device, to acquire the attribute information and the work-content information from the relational data management device based on identification information of a user and identification information of an organizational unit, to analyze the acquired attribute information and the acquired work-content information to compute a correspondence relationship between professional capabilities and preferences of the user and candidate work items executable in the organizational unit, to select a work item suitable for the user from among the candidate work items, to generate, in a natural language, a prompt sentence including a selection result of the work item, to input the prompt sentence to a generative AI model that performs natural language generation processing, to acquire response information including work content to be assigned to the user from the generative AI model, to extract task identification information and work-content information specified in the response information and format the task identification information and the work-content information as structured task information, to acquire, based on the structured task information, equipment identification information and control parameters associated with the work-content information, to generate work instruction information including the equipment identification information and the control parameters, to transmit the work instruction information to an external terminal device via a communication network, and to record work progress information and work completion information transmitted from the terminal device in the relational data management device so as to store a recording result as learning history information for use in subsequent generation of the prompt sentence and subsequent selection of the candidate work items. This enables the computer system to internally convert heterogeneous user and work data into expressive prompt sentences, to leverage the generative AI model as a flexible computation component for deriving structured task assignments, to automatically translate such assignments into machine-executable work instruction information for terminal devices, and to continuously refine future prompt construction and assignment decisions based on execution feedback, thereby improving the technical performance, adaptability, and resource utilization of the work-assignment processing executed by the server.

The term “processor” refers to one or more hardware-based processing units, such as a central processing unit or a microcontroller, configured to execute instructions to perform data processing operations described in the present specification.

The term “memory” refers to one or more non-transitory computer-readable storage media, such as semiconductor memory, magnetic storage, or optical storage, configured to store instructions and data for use by the processor.

The term “relational data management device” refers to one or more hardware and software components implementing a relational data model, such as a relational database management system, configured to store, manage, and retrieve data records using relational structures.

The term “attribute information” refers to structured data representing properties of an individual user, including at least professional capabilities, skills, preferences, and other user-related characteristics used for work assignment.

The term “work-content information” refers to structured data representing properties of work to be performed in an organizational unit, including at least task descriptions, required capabilities, procedures, and other task-related characteristics.

The term “organizational unit” refers to a logical or physical subdivision within an organization, such as a department, group, or team, to which specific work-content information is associated.

The term “identification information” refers to data that uniquely or distinctively identifies an entity, such as a user, an organizational unit, or equipment, including identifiers such as IDs, codes, or keys.

The term “candidate work items” refers to a plurality of work entities or tasks that are available for assignment to a user within an organizational unit and that are evaluated by the processor for suitability.

The term “professional capabilities” refers to attributes of a user related to expertise, qualifications, technical skills, and proficiency levels relevant to execution of work items.

The term “preferences” refers to attributes of a user indicating likes, interests, or favored types of work or conditions, which are considered by the processor when selecting a work item.

The term “prompt sentence” refers to a textual sequence expressed in a natural language that encodes user-related information, work-related information, or both, and that is provided as input to a generative AI model to elicit a response.

The term “generative AI model” refers to a machine-learned model configured to generate natural language or structured content in response to input data, such as a large-scale neural network language model.

The term “response information” refers to data output from the generative AI model in response to a prompt sentence, including at least an indication of work content to be assigned to a user and optionally explanation information.

The term “task identification information” refers to data that uniquely or distinctively identifies a work item or task generated or selected for assignment, such as a task ID or task code.

The term “work-content information” in the context of structured task information refers to the specific description, parameters, and characteristics of the work to be performed as determined from the response information.

The term “structured task information” refers to a data structure obtained by formatting or organizing task identification information and work-content information into a machine-readable form suitable for further processing by the processor.

The term “equipment identification information” refers to data that identifies equipment, machinery, or devices to which a work item is to be assigned, such as a machine ID or equipment code.

The term “control parameters” refers to machine-executable settings, values, or configuration data used for controlling equipment to perform a work item, such as operating speeds, temperatures, timing parameters, or modes.

The term “work instruction information” refers to a data set including at least task identification information, equipment identification information, and control parameters, which is transmitted to a terminal device for execution or display.

The term “terminal device” refers to an external computing apparatus, such as an industrial controller, workstation, or portable terminal, configured to receive work instruction information, interface with equipment, and provide information to a user.

The term “communication network” refers to any wired or wireless communication infrastructure enabling data exchange between the server and the terminal device, including local area networks, wide area networks, or industrial communication networks.

The term “work progress information” refers to data indicating a current state or intermediate status of execution of a work item, including at least start, pause, error, or in-progress conditions.

The term “work completion information” refers to data indicating that execution of a work item has been finished, including at least completion status, completion time, and optionally outcome-related notes.

The term “learning history information” refers to data derived from recorded work progress information and work completion information, stored for use in subsequent processing to improve prompt generation, work selection, or both.

The term “explanation information” refers to text or structured data that describes a reason or justification for selection of a work item, suitability of a task for a user, or related decision-making details.

The term “performance indicators” refers to metrics computed per user or per work item based on execution results, such as completion times, quality measures, or success rates, used to characterize performance over time.

In one embodiment, a server executes a task-assignment system that cooperatively operates with at least one terminal and at least one user in an industrial environment such as a manufacturing facility. The server includes a processor and a memory storing instructions, and the server communicates with a relational data management device and the terminal via a communication network.

The server uses general-purpose server hardware, for example, a rack-mounted information processing device including a multi-core central processing unit, volatile memory, non-volatile storage, and a network interface. The server executes an operating system such as a general-purpose server operating system and an application stack including a database client library, an HTTP server framework, and a software development framework for interacting with a generative AI model. The server accesses a relational data management device that can be implemented by a relational database management system such as a general-purpose relational database engine.

The server stores, in the relational data management device, attribute information related to each user and work-content information related to each organizational unit. The server stores the attribute information in structured relational tables, for example, a first table including user identifiers, professional capabilities, and skill levels, and a second table including user identifiers and preference information such as interests or favored task types. The server stores the work-content information in one or more additional tables including task identifiers, textual task descriptions, required capability sets, default control parameters, and mappings to equipment identifiers associated with machines or devices on the shop floor. The server thereby normalizes and indexes the attribute information and the work-content information in a machine-efficient format.

The server acquires, from the relational data management device, a set of attribute information corresponding to a particular user identifier and a set of work-content information corresponding to a particular organizational unit identifier. The server uses SQL-based queries with defined schemas and indexes to retrieve only a relevant subset of records, thereby reducing input/output overhead and improving data access latency. The server converts retrieved rows into in-memory data structures, such as arrays and key-value mappings, in which each professional capability and each required skill is represented by a normalized symbolic identifier. This normalization allows the server to compute intersections, similarity scores, and coverage metrics using efficient set-based operations rather than repeated string comparisons.

The server analyzes the attribute information and the work-content information to compute a correspondence relationship between the user's professional capabilities and preferences on one side, and candidate work items on the other side. The server computes, for each candidate work item, a suitability score that combines at least: (i) a capability match factor based on the overlap between required capabilities and the user's capabilities; (ii) a preference match factor based on whether the task type is listed as preferred by the user; and (iii) a historical performance factor based on performance indicators stored as part of learning history information. The server represents these factors as numeric values and combines them using a non-linear weighting formula that can be tuned empirically. The server thereby identifies a subset of high-ranking candidate work items.

The server generates a prompt sentence for a generative AI model by transforming the internal structured data (capabilities, preferences, candidate work items, and historical performance) into a natural language format. The server uses a prompt-construction module that maps each normalized capability identifier and task identifier into an explanatory phrase using template rules. The server concatenates these phrases into a prompt sentence and encloses them within a fixed instruction pattern. For example, the server may generate a prompt sentence such as:

“User expertise: welding technology and machine operation.

User skills: welding, operation of automated machinery.

User interests: precision work, safety, process improvement.

Available tasks in the department:
1. Task ID: T1, Name: Chassis welding, Required skills: welding.
2. Task ID: T2, Name: Operation of automatic cutting machines, Required skills: machine operation.
3. Task ID: T3, Name: Final visual inspection, Required skills: quality inspection.

Historical context: The user has successfully completed 50 welding tasks with high quality and on-time delivery.

Based on the user's skills, interests, and historical performance, choose the single most suitable task from the tasks listed above and explain your choice briefly. Output the chosen task ID and a short explanation.”

The server then inputs this prompt sentence to a generative AI model. In one embodiment, the generative AI model is a transformer-based neural network language model that includes multiple layers of self-attention blocks, feed-forward networks, layer normalization, and residual connections. The generative AI model uses token embeddings to represent individual subword tokens, positional encodings to encode token order, and multi-head attention mechanisms to compute context-aware hidden representations. The generative AI model has been trained offline using supervised learning and unsupervised learning on large corpora of text data, and may be further fine-tuned using domain-specific conversational data including prompts and desired responses for task assignment scenarios.

The server communicates with the generative AI model via an application programming interface exposed by a model-serving subsystem. The server encodes the prompt sentence into a sequence of tokens, transmits the token sequence to the model-serving subsystem over a network connection, and receives one or more output token sequences that represent the response information. Internally, the generative AI model computes, at each decoding step, a probability distribution over possible next tokens, based on attention-weighted combinations of preceding tokens and internal learned parameters. The generative AI model outputs text that includes at least one task identifier and a natural language explanation of why the task is suitable for the user.

The server parses the response information to extract task identification information and work-content information. The server applies deterministic parsing rules, such as pattern matching on the phrase “Task ID:” followed by an alphanumeric sequence, and extracts the first valid task identifier present in the response text. The server optionally uses additional parsing logic to extract structured explanation information and other decision-related attributes. The server then creates structured task information in which the task identification information, work-content information, and explanation information are stored in machine-readable fields rather than as unstructured text.

The server acquires, based on the structured task information, equipment identification information and control parameters associated with the chosen task. The server queries the relational data management device to fetch the equipment mapping for the selected task identifier and to retrieve default control parameters such as operating speed, temperature, or timing. The server may refine the control parameters using user-specific or machine-specific configuration tables. The server constructs work instruction information that includes the task identifier, the equipment identifier, the control parameters, and the explanation information. This work instruction information is formatted in a compact and standardized structure that facilitates efficient transmission and decoding by the terminal.

The server transmits the work instruction information to the terminal via a communication network. The server uses a network protocol such as HTTP or an industrial messaging protocol to deliver the work instruction information to a network address associated with the terminal. The server may apply serialization formats and compression techniques to reduce payload size, thereby reducing communication load and transmission latency. The server maintains transaction logs and error-handling logic to detect failed transmissions and to retry delivery if necessary.

The terminal is implemented as an industrial computing device such as an industrial personal computer, a programmable logic controller gateway, or a ruggedized tablet connected to production equipment. The terminal includes its own processor, memory, and network interface. The terminal runs an application that receives work instruction information from the server, parses the data, and maps control parameters and equipment identifiers to specific control commands that can be executed by the connected machines. The terminal communicates with machines through industrial communication protocols such as fieldbus protocols, message-based industrial standards, or direct controller interfaces.

The terminal converts the equipment identification information and control parameters into low-level signals used by the machine's controller. For example, the terminal may set register values representing operating modes, speeds, and safety thresholds, and then invoke a start command for the job referenced by the task identifier. The terminal thereby implements a concrete, technical linkage between the server's generative-assignment logic and the physical operation of machines in the real world. This arrangement contrasts with abstract business workflows because the output of the generative AI model ultimately drives control parameters that change machine behavior and production output.

The terminal provides a user interface through which the user can view assigned work items, explanation information, and machine status information. The terminal displays, for example, the task identifier, task description, machine identifier, and major control parameters, along with the explanation generated by the generative AI model, such as “This task is recommended because the user's primary expertise is welding and the user has historically completed welding tasks with high quality.” The user thereby gains transparent insight into the assignment while the underlying system maintains machine-level control.

The user interacts with the terminal to acknowledge, start, pause, or complete assigned work items. The user may also provide optional notes regarding any abnormal events or quality issues encountered during execution. The terminal captures these interactions as work progress information and work completion information, attaching timestamps and user identifiers. The terminal transmits this feedback data to the server through the communication network.

The server receives the work progress information and the work completion information and records these data in the relational data management device as history records. The server updates performance indicators per user, such as average completion time by task type, success rate, or occurrence frequency of machine errors. The server then integrates these performance indicators into future prompt sentences, for example by adding historical context paragraphs that reflect the user's strong or weak performance in specific categories of tasks. This closed-loop process allows the generative AI model to condition its outputs on updated performance signals.

The server thereby uses the generative AI model not merely as an abstract assistant but as a specialized computational component embedded into a technical architecture that combines relational data structures, deterministic pre-filtering and parsing logic, and machine control integration. The server improves computational efficiency and accuracy by (i) pre-selecting candidate work items using explicit set-based matching before invoking the generative AI model, reducing the length and breadth of the prompt sentence; (ii) representing structured attributes in normalized forms that minimize redundancy and simplify mapping to text; and (iii) reusing learned history information to bias future assignments in a data-driven manner, thereby reducing trial-and-error and improving convergence toward stable task allocations. This technical architecture improves computer technology in several respects. First, the server reduces overall processing time and network overhead by filtering candidate tasks using efficient database operations and compact prompt sentences, which reduces the number of tokens and computational steps required in the generative AI model. Second, the server increases assignment precision by integrating multiple data dimensions—capabilities, preferences, and performance indicators—into a unified prompt structure that the generative AI model can interpret with higher contextual awareness. Third, the server enhances data management by maintaining a consistent representation of tasks and performance metrics across both the relational data management device and the generative AI interaction layer, thereby avoiding duplicated or inconsistent data structures. Fourth, the server decreases control errors at the equipment level by translating generative decisions into machine-verified control parameters, which are validated against equipment-specific constraints stored in the relational data management device before being transmitted to the terminal.

The server employs non-conventional processing rules compared to traditional rule-based task assignment. Rather than using a static set of if-then conditions, the server uses a hybrid method in which a deterministic pre-selection algorithm constrains the search space and a generative AI model, with its multi-layer attention mechanism, computes nuanced trade-offs that would be difficult to encode manually. The server leverages the generative AI model's internal learned distributions to combine multiple input signals in a high-dimensional semantic space while still grounding the final output in explicit task identifiers and control parameters. This non-traditional combination of pre-filtering, prompt-based generation, and structured post-parsing yields improvements in both assignment quality and computational robustness.

In another embodiment, the server may adjust how prompt sentences are composed. For instance, the server can include additional features such as estimated machine idle time, maintenance schedules, and safety constraints in the prompt text. The server may also apply different templates for different types of organizational units, such as assembly, inspection, or logistics, while keeping the same underlying data structures. In yet another embodiment, the server may execute the generative AI model locally on a dedicated inference accelerator rather than accessing a remote service, using a model instance that follows the same transformer architecture but is quantized or pruned to meet hardware constraints. In such a variation, the server reduces network latency and external dependencies, thereby improving reliability and response time.

In still another embodiment, the server can modify the weighting of performance indicators in the suitability score calculation. For example, the server may prioritize completion time for high-throughput lines and prioritize quality metrics for safety-critical operations. These variations do not alter the core architecture, in which the server aggregates structured attribute information and work-content information, constructs and issues prompt sentences to a generative AI model, derives structured assignments from the responses, generates work instruction information including equipment identification information and control parameters, and updates learning history information based on feedback from the terminal and the user.

Through these embodiments, the server, the terminal, and the user cooperate in a technically integrated system where generative AI processing is tightly coupled with structured data management and equipment control. The server thereby provides a concrete improvement to computer-based task assignment, enabling higher precision, greater adaptability, and more efficient resource usage in real-world industrial environments.

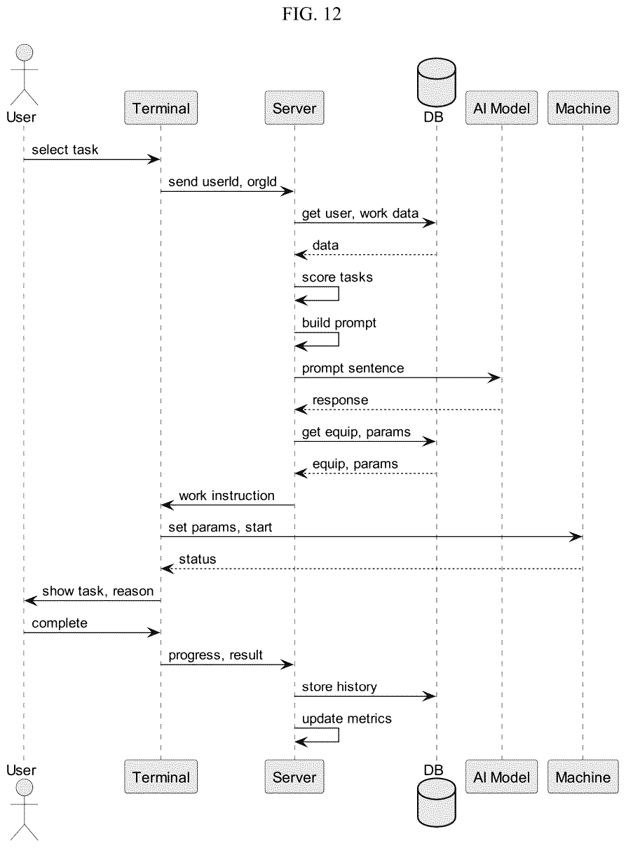

The following describes the processing flow using FIG. 12.

Step 1:

The server receives, as input, a user identifier and an organizational-unit identifier from the terminal or from an external application over a communication network. The server uses this input to access a relational data management device and retrieve, as output, attribute information for the specified user and work-content information for the specified organizational unit. The server performs data-processing operations including execution of indexed database queries, conversion of query results into in-memory data structures, and normalization of capability and preference identifiers so that subsequent matching computations can be executed efficiently.

Step 2:

The server computes, as input, the normalized attribute information and the work-content information received from the relational data management device. The server outputs a set of candidate work items each associated with an internal suitability score. The server performs data-operations including set-intersection between user capabilities and required capabilities, numeric weighting of preference matches, and combination of these metrics into a composite score for each work item. Based on these scores, the server filters out low-scoring work items and ranks the remaining items, thereby generating a reduced and ordered candidate set.

Step 3:

The server takes, as input, the ranked candidate work items, the user's capabilities, preferences, and any available performance indicators. The server generates, as output, a prompt sentence expressed in natural language for a generative AI model. The server performs data formatting operations by mapping symbolic identifiers to descriptive phrases, applying template rules to arrange those phrases into sentences, and concatenating them into a single structured prompt. The server thereby encodes high-dimensional structured data into a textual representation suitable for natural language processing.

Step 4:

The server provides, as input, the generated prompt sentence to the generative AI model via a model-serving interface. The server receives, as output, response information including at least one proposed task identifier and a natural language explanation. The server performs operations including tokenization of the prompt sentence, transmission of encoded tokens to the model-serving subsystem, and reception of a decoded text sequence from the generative AI model. The generative AI model internally executes attention-based computations over the token sequence, but the server focuses on orchestrating data flow to and from the model.

Step 5:

The server uses, as input, the response information returned by the generative AI model. The server outputs structured task information including task identification information, selected work-content information, and associated explanation information. The server performs parsing operations such as pattern matching on response text to extract a valid task identifier, correlation of the extracted identifier with the pre-existing work-content records, and organization of these fields into a structured record. The server thereby converts unstructured model output into a deterministic, machine-readable format.

Step 6:

The server accepts, as input, the structured task information including the selected task identifier. The server outputs work instruction information that additionally includes equipment identification information and control parameters. The server performs a lookup operation in the relational data management device to find equipment mappings and default control settings linked to the task identifier, merges this information with the structured task information, and validates that the control parameters fall within allowed ranges for the specified equipment. As a result, the server produces a complete instruction set that can drive real equipment through a terminal.

Step 7:

The server uses, as input, the work instruction information generated in the previous step. The server outputs a transmitted message containing the work instruction information addressed to a specific terminal. The server performs serialization, optional compression, and network-transmission operations using a selected communication protocol. The server monitors acknowledgment signals or response codes from the terminal and records the transmission status. The server thus ensures that the work instruction information is reliably delivered to the correct terminal for execution.

Step 8:

The terminal receives, as input, the transmitted work instruction information from the server over the communication network. The terminal outputs internal control structures containing parsed task identifiers, equipment identifiers, and control parameters. The terminal performs deserialization and validation of the received data, maps the equipment identifier to a locally configured machine interface, and stores the control parameters in a memory area reserved for active jobs. This processing prepares the terminal to translate high-level instructions into low-level machine commands.

Step 9:

The terminal takes, as input, the control parameters and equipment identifier stored in its internal control structures. The terminal outputs machine-specific control commands that are communicated to a connected machine controller. The terminal performs data-conversion operations that map each abstract control parameter to a hardware register, function call, or protocol message defined by the machine interface. The terminal then issues start, stop, or configuration commands based on the task state, thereby initiating or adjusting physical machine operation according to the server's assignment.

Step 10:

The terminal presents, as input, the work instruction information and explanation information to the user through a human-machine interface. The terminal outputs a visual display screen containing task details such as task name, machine identifier, key parameters, and the reason for assignment. The terminal performs rendering operations including layout calculation, text formatting, and status icon updates. This allows the user to understand both what task has been assigned and why it is suitable, as computed by the server-model pipeline.

Step 11:

The user views, as input, the displayed work instruction information and explanation information on the terminal. The user outputs physical actions to perform the assigned work, as well as interface actions such as pressing “start,” “pause,” or “complete” buttons on the terminal. The user interprets parameter values, prepares necessary materials, and supervises the machine according to the displayed instructions. These user actions cause the terminal to update internal status flags representing the current progress of the task.

Step 12:

The terminal collects, as input, user interface actions and machine status signals during execution of the assigned task. The terminal outputs work progress information and work completion information to the server. The terminal performs data aggregation by combining machine status flags, timestamps, and user-entered notes into structured status records. The terminal then transmits these records back to the server over the communication network, thereby closing the feedback loop.

Step 13:

The server receives, as input, the work progress information and work completion information from the terminal. The server outputs updated records in the relational data management device and updated performance indicators for the user. The server performs insert and update operations on history tables, computes new performance metrics such as average completion time or success rate for specific task categories, and stores these metrics as learning history information. This processing enriches the dataset used in future assignment computations.

Step 14:

The server uses, as input, the updated learning history information and performance indicators stored in the relational data management device. The server outputs refined suitability scores and enhanced prompt sentences for subsequent assignment cycles. The server adjusts weighting coefficients in its suitability calculations, incorporates performance summaries into future prompt sentences, and thereby alters the data that will be provided to the generative AI model. Through this iterative refinement, the server improves the accuracy and efficiency of future assignments and reduces the need for manual reconfiguration.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented recommendation systems for internal job placement and colleague discovery typically rely on fixed rule engines, manually designed matching logic, or simple keyword search against structured records. Such systems suffer from several technical limitations in the way they process and utilize natural language inputs, user state signals, and heterogeneous organizational data. For example, many existing systems: (i) parse natural language requests using shallow pattern matching that cannot robustly capture user intent or nuanced constraints; (ii) execute static database queries that are not dynamically adapted to the semantics of the user's request; and (iii) provide recommendations without generating machine-understandable intermediate structures that can be reused, audited, or refined in subsequent processing cycles.

As a result, the processor in such systems often performs multiple redundant transformations between unstructured and structured representations, leading to increased processing latency, higher utilization of computing resources, and reduced scalability when handling large numbers of concurrent users and large organizational databases. Additionally, conventional architectures rarely integrate emotional state analysis derived from sensor data or user inputs into the core query and recommendation pipeline, so the system is not able to adapt its search space or explanation style based on the user's current emotional context. This limits the effectiveness of the recommendation results and can also increase the number of user interactions needed to converge on an appropriate department or person match, thereby increasing overall system load.

Further, existing systems that utilize generative AI models usually treat such models merely as front-end “chat” components, without systematically using prompt sentences to drive a sequence of machine-oriented operations including: (i) extraction of structured intent and ability elements; (ii) generation of query parameters for a backend database; and (iii) generation of explanation texts conditioned on both recommendation results and user state. In these systems, generative AI outputs are often consumed only in free-text form, which forces subsequent modules to rely on secondary heuristic parsing, leading to error propagation and inefficiencies in memory and CPU usage.

There is therefore a need for a computer-implemented technique that improves the way a processor orchestrates interactions between a generative AI model, a database system, and user-facing terminals, by: (i) systematically generating and using prompt sentences to extract structured information from natural language inputs; (ii) using such structured information to formulate efficient database queries and quantitative suitability indices; and (iii) integrating emotional state analysis into both the prompt generation and the recommendation generation processes. By addressing these issues, the system can improve the accuracy and contextual relevance of recommendations, reduce unnecessary computation through better-structured data flows, improve response time, and provide more adaptive and efficient computer operation when matching users to departments and persons within an organization.

The specific processing by the specific processing unit 290 of the data processing device 12 in Example 2 is realized by the following means.

The present invention provides a server comprising a processor configured to receive, via a terminal, a natural language request and attribute information regarding a user, and to aggregate the request and the attribute information as record information in an information storage device; to generate, based on the request and the attribute information, a first prompt sentence for input to a generative AI model, instruct the generative AI model by using the first prompt sentence to extract structured information regarding an intention of the request and an ability of the user, and acquire the structured information from the generative AI model; to generate, based on a desired activity content and ability elements included in the structured information, a query command for an information storage device in which department information and person information are stored, and search the department information and the person information in accordance with the query command; to calculate, by using a data processing program, a suitability index by comparing the department information and the person information acquired by the search with ability information of the user, and select department candidates and person candidates having a high suitability with respect to the user; to generate, based on the selected department candidates and person candidates, the suitability index, and the ability information of the user, a second prompt sentence for input to the generative AI model, and instruct the generative AI model by using the second prompt sentence to generate recommendation content and an explanatory text to be presented to the user, and acquire a generation result; to transmit the acquired recommendation content and the explanatory text to the terminal as output data, and cause the terminal to present the recommendation content and the explanatory text visually or aurally to the user; and to analyze an emotional state of the user based on input information from the user and state information obtained from a detection device, and include an analysis result in at least one of the first prompt sentence and the second prompt sentence to be fed back to the generative AI model. This enables a technically improved recommendation pipeline in which the processor coordinates structured interactions between the generative AI model and the database, reduces redundant parsing and heuristic processing, adapts search and explanation behavior to the user's emotional state, and thereby improves computational efficiency, scalability, and accuracy of department and person recommendations in a computer system.

The term “processor” refers to an information processing element, such as a central processing unit or other programmable computing circuitry, that executes instructions of one or more programs to perform the functions described in the present specification and claims.

The term “terminal” refers to an information processing apparatus, such as a client device including a display and an input interface, that communicates with a server over a communication network to transmit user inputs and receive output data.

The term “user” refers to a human operator who interacts with the terminal to input requests, attribute information, and other data, and who receives recommendation content and explanatory text generated by the system.

The term “natural language request” refers to a request expressed in a human language, including free-form text or speech-recognized text, which describes at least one intention, preference, or inquiry of the user.

The term “attribute information” refers to information associated with the user, including but not limited to skill information, career information, preference information, and other profile-related data that can be used for matching and recommendation processing.

The term “information storage device” refers to a storage resource, such as a memory device or a database system, that stores record information, department information, person information, and other data used by the processor.

The term “record information” refers to data stored in the information storage device that represents at least a natural language request and attribute information of a user in a machine-readable format.

The term “generative AI model” refers to a machine learning model, including a generative model or a large language model, that generates output data such as structured information or text based on input data including prompt sentences.

The term “prompt sentence” refers to an input sequence, including text or token data, provided to the generative AI model to specify a processing task, a required output format, or contextual information for generation.

The term “structured information” refers to information expressed in a defined data structure, such as key-value pairs, lists, or tables, that can be programmatically accessed and processed by the processor without natural language interpretation.

The term “intention of the request” refers to a semantic representation of what the user aims to achieve or inquire about by the natural language request, such as a desire to find a suitable department or to evaluate a career option.

The term “ability of the user” refers to a set of capability elements associated with the user, including skills, knowledge, experiences, and competencies that can be used for suitability calculation.

The term “desired activity content” refers to an activity, role, or job-related function indicated or inferred from the structured information extracted from the natural language request.

The term “ability elements” refers to constituent items of the ability of the user, such as individual skills, technical knowledge areas, or behavioral competencies.

The term “department information” refers to data describing organizational units, including identifiers, names, job descriptions, required skills, and other attributes related to departments.

The term “person information” refers to data describing individuals within an organization, including identifiers, affiliation information, skill information, and interest information, which can be used for matching with the user.

The term “query command” refers to a command or parameter set, such as a database query expression, generated by the processor to request retrieval of department information or person information from the information storage device.

The term “data processing program” refers to a program executed by the processor for performing data manipulation, analysis, comparison, or calculation, including the computation of suitability indices.

The term “suitability index” refers to a quantitative or ordinal value calculated by the processor that represents a degree of correspondence between the user's ability information and department information or person information.

The term “department candidates” refers to one or more departments selected by the processor from among available departments based on the suitability index as being suitable for the user.

The term “person candidates” refers to one or more persons selected by the processor from among available persons based on the suitability index or interest matching as being relevant to the user.

The term “recommendation content” refers to structured or semi-structured data describing at least one department candidate or person candidate, and optionally including suitability indices and other metadata, generated for presentation to the user.

The term “explanatory text” refers to natural language output that explains, clarifies, or justifies recommendation content in a form understandable by the user.

The term “output data” refers to data transmitted from the server to the terminal, including recommendation content and explanatory text, and optionally including associated metadata for presentation control.

The term “detection device” refers to a sensor or sensing subsystem, such as a camera, microphone, physiological sensor, or input log collector, that acquires state information related to the user or the user's interaction context.

The term “state information” refers to data obtained from a detection device or from the terminal that indicates at least one physical, behavioral, or interaction state of the user.

The term “emotional state” refers to an estimated affective condition of the user, such as stress, satisfaction, confusion, or motivation, inferred from state information and user inputs.

The term “analysis result” refers to processed information obtained by evaluating user inputs and state information, including at least an estimation of the user's emotional state used for subsequent prompt generation and recommendation control.

In one embodiment, a server cooperates with at least one terminal and at least one information storage device to implement the claimed system. The server includes a processor, a main memory, a non-volatile storage device, and a network interface. The processor executes a plurality of software modules, including a web application module, a database access module, a data processing module, an emotional state analysis module, and a generative AI interface module. The server is connected to the terminal through a communication network. The terminal includes a display, an input interface such as a touch panel or keyboard, a local memory, and a communication interface.

The server uses a server-class processor, such as a multi-core general purpose central processing unit, and executes an operating system such as a general-purpose server operating system. The server stores application logic in a server-side framework such as a web application framework implemented in a high-level programming language. The server accesses the information storage device, which is implemented as a relational database management system such as a general-purpose relational database, running on the same machine or on a separate database server connected through the network. The server also uses a data analysis library such as a general-purpose numerical computing library and a table-based data manipulation library. The terminal uses an operating system for mobile or desktop devices and executes a client application implemented, for example, in a mobile application framework or a browser-based interface.

The server aggregates user-related information in the information storage device. The server stores, in a user table, records including a user identifier, profile fields such as skill tags, experience level, department affiliation, and interest categories. The server stores, in a department table, records including a department identifier, a department name, a textual job description, and a list of required skills represented as normalized skill identifiers. The server stores, in a person table, records including a person identifier, affiliation data, skill tags, and interest tags. The server also stores, in a request table, records including the user identifier, a natural language request string, a timestamp, and metadata for each request.

The server uses the generative AI interface module to interact with a generative AI model. In one embodiment, the server communicates with a transformer-based language model deployed on a separate inference server or accessed via an external service API. The generative AI model includes an encoder-decoder or decoder-only neural network configured as a multi-layer transformer architecture. The generative AI model uses multi-head self-attention layers, feed-forward layers, and layer normalization. The model parameters include weight matrices for attention projections and feed-forward sub-networks, which are stored in the inference server and loaded into memory at runtime.

The server constructs a prompt sentence as plain text to control behavior of the generative AI model. The server uses a deterministic prompt template to reduce variability in output structure and to ensure that the generative AI model returns structured, machine-readable content. For example, the server generates a prompt sentence such as:

“User request: ‘I want to do FA, but I don't know which department is suitable for me.’

User skills: financial analysis basics, spreadsheet operation, communication.

Task:
1. Identify the main intent of the user.
2. Identify the desired activity or department.
3. List key skills and interests implied by the request.

Output format:

intent: . . .

target_activity: . . .

key_skills: . . .

key_interests: . . . ”

The server sends this prompt sentence to the generative AI model via the generative AI interface module. The generative AI model receives the prompt sentence, tokenizes the text into subword units, processes the token sequence through multiple transformer layers, and produces output token probabilities. The generative AI model uses a decoding algorithm, such as greedy decoding or beam search, to generate an output text string that follows the requested output format. The server receives the output text, performs pattern-based parsing or rule-based extraction, and converts the text into a structured internal representation, such as a dictionary mapping “intent”, “target_activity”, “key_skills”, and “key_interests” to string or list values.

The server uses the data processing module to map the extracted “target_activity” and “key_skills” to internal skill identifiers and department category identifiers. The server applies normalization rules stored in a skill normalization table. The server then uses the database access module to generate parameterized queries for the relational database. The server queries the department table and the department-skill relationship table to obtain candidate departments whose required skills intersect with the user's key skills or match the target activity category. The server retrieves from the database a set of department records and associated required skill lists.

The server processes the retrieved department data with the data processing module. The server uses a tabular data representation to store the candidate departments and their required skills. The server calculates a suitability index for each candidate department based on a deterministic scoring algorithm. For example, the server computes the suitability index as a weighted sum of matched skills divided by a normalization factor that accounts for the total number of required skills. The server assigns higher weights to skills classified as core skills in a skill weight table. The server also can incorporate similarity measures based on distributed skill embeddings precomputed during an offline training phase. In that phase, the server uses a neural embedding model to learn vector representations of skills from historical co-occurrence data in department and person profiles, and stores the resulting vectors in the database. During online processing, the server calculates cosine similarity between the user's skill vector and each department's skill vector to refine the suitability index.

The server selects department candidates whose suitability index exceeds a threshold and sorts them in descending order of suitability. The server optionally retrieves person information for persons affiliated with the candidate departments who share overlapping skills or interests with the user. The server merges the person data into the same tabular structure and calculates a secondary suitability index for person candidates based on the ratio of shared interests and skills.

The server analyzes an emotional state of the user using the emotional state analysis module. The terminal acquires state information from at least one detection device, such as a camera, microphone, or biometric sensor, and transmits derived features to the server. For example, the terminal performs local pre-processing to extract speech prosody features, typing speed statistics, or facial expression features. The server combines these features with self-reported mood indicators entered by the user, such as a selection on a mood scale. The server applies a classification model, such as a neural network with fully connected layers or a recurrent network, trained to map feature vectors to discrete emotional categories like “confused”, “confident”, or “stressed”. The server outputs an analysis result indicating the emotional state and a confidence score.

The server incorporates the emotional state into subsequent prompt sentences. For example, the server generates an explanation-oriented prompt sentence such as:

“User skills: financial analysis basics, spreadsheet operation, communication.

Candidate departments and suitability scores:
Corporate Finance Department: score 0.86
Business Planning Department: score 0.74

User emotional state: confused, low confidence.

Task:

Explain to the user, in simple and reassuring language, why the Corporate Finance Department is the most suitable choice.

Highlight the user's strengths and suggest one or two concrete next steps to prepare for this department.”

The server sends this explanation prompt sentence to the generative AI model. The generative AI model generates an explanatory text that is conditioned not only on the department data and skills, but also on the emotional state attribute. The server receives the explanatory text, packages it together with the structured recommendation content, and transmits the combined output data to the terminal.

The terminal displays the recommendation content and the explanatory text using graphical user interface components. The terminal presents a list of recommended departments, each with a suitability index, a short description, and a link to more detailed information. The terminal also displays the explanatory text in a readable format, possibly adjusting font size or presentation mode depending on accessibility settings. The terminal may output audio using text-to-speech functionality to present the explanatory text aurally.

The server improves computer operation in several technical aspects. The server uses structured prompt sentences and constrained output formats to avoid ad-hoc parsing of free-form generative outputs, thereby reducing CPU cycles and memory allocations otherwise required for heuristic post-processing. The server reduces database query load by converting natural language requests into structured intent and skill representations before query generation, which leads to narrower and more targeted queries. This reduction in query breadth decreases disk I/O and network traffic between the application server and the database server. The server also improves response time because the structured interaction with the generative AI model allows reuse of intermediate structured information, so the server does not need to re-interpret the entire conversational history for each new request. The server further improves accuracy and robustness by combining deterministic data processing with learned representations. The server does not rely solely on human-designed rule engines, but instead uses a hybrid approach in which the generative AI model performs semantic extraction under strict prompt control, and the server uses explicit scoring algorithms based on normalized data structures. The server's use of precomputed skill embeddings reduces the dimensionality of similarity calculations and improves the discrimination between departments in cases where direct keyword overlap is limited.

The generative AI model used by the server can be trained beforehand on a corpus of technical and organizational texts. The training process uses supervised learning or self-supervised learning, with an objective that minimizes a loss function such as cross-entropy between predicted tokens and ground-truth tokens. During training, the model updates its weights by backpropagation, using an optimization algorithm such as stochastic gradient descent or an adaptive optimizer. The server may additionally fine-tune the model on domain-specific data, including anonymized historical requests and successful department matches. This fine-tuning improves the model's ability to map user requests to appropriate internal representations and reduces output variance, which further decreases the need for corrective processing in the server.

The server may implement different variants of the system. In one variant, the generative AI model runs locally on the same physical machine as the server, using a dedicated graphics processing unit or specialized accelerator to perform matrix operations of the transformer layers. In another variant, the generative AI model is accessed via a network service, and the server batches multiple prompt sentences from different users into a single request to the model, thereby reducing communication overhead and improving throughput. The server may also vary the decoding parameters used by the generative AI model, such as temperature or top-k values, depending on whether the task is extraction of structured information or generation of explanatory text.

The server can execute the emotional state analysis either centrally or in a distributed fashion. In one embodiment, the terminal performs initial feature extraction, and the server performs classification and fusion with other user data. In another embodiment, the terminal executes a lightweight classification model and transmits only the resulting emotional state label and confidence score to the server, which reduces bandwidth and protects sensitive raw sensor data. The server then uses the emotional state label as a discrete feature in prompt construction and in selection of explanation style, thereby adjusting the level of detail and tone to suit the user's current condition.

The system exhibits technical effects that go beyond simple automation of human tasks. Because the server uses specially structured prompt sentences, controlled output formats, and explicit scoring algorithms operating on normalized data structures, the server avoids repeated full-text parsing and can reuse intermediate structured representations across multiple stages. This architecture decreases processing latency and improves scalability when multiple users access the system concurrently. The combination of structured extraction, vector-based similarity calculation, and emotional state-aware prompt generation yields more accurate and contextually appropriate department and person recommendations, which reduces the number of interaction rounds and network messages required to reach a satisfactory recommendation. As a result, the system reduces communication load and computation resources per successful recommendation.

The server can be configured in additional alternative embodiments. In one embodiment, the server maintains a cache of recent structured requests and corresponding recommendation results, indexed by abstracted intent and skill vectors. When a new user request yields a similar structured representation, the server retrieves a cached result and only uses the generative AI model for explanation tailoring, which further reduces calls to the generative AI model and lowers inference load. In another embodiment, the server periodically retrains or updates the scoring weights for the suitability index based on observed user feedback stored in a feedback table, such as whether the user accepted a recommended department or requested alternatives. This feedback-driven adjustment refines the numerical parameters of the scoring algorithm and improves long-term accuracy without changing the overall architecture.

The terminal, the server, and the information storage device thereby cooperate in a technically specific manner. The terminal captures natural language input and sensor-derived features, the server transforms unstructured text into structured data through controlled interaction with a generative AI model, the server executes quantitative comparisons and similarity calculations on structured records in the database, and the terminal displays or outputs recommendations and explanations adapted to the user's state. By using these coordinated components, the system achieves improved computer-implemented recommendation performance in terms of speed, precision, and resource utilization, and provides an implementation that does not merely computerize a human mental process, but instead improves the functioning of the underlying computer system itself.

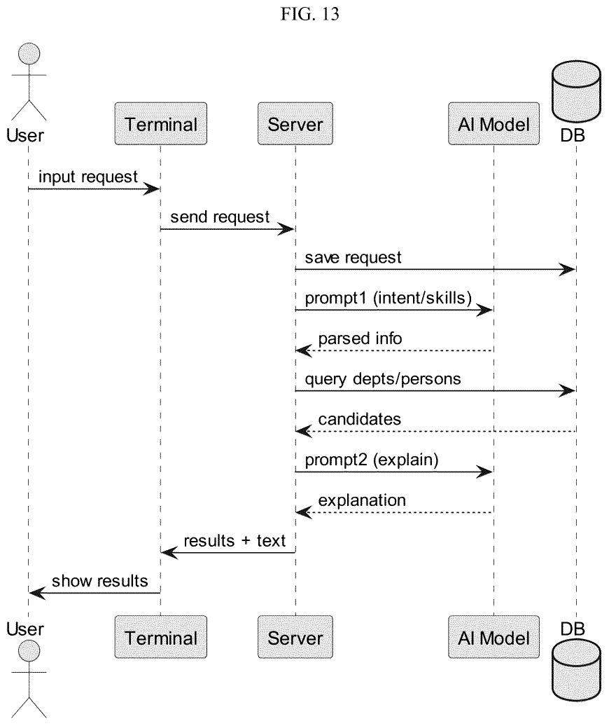

The following describes the processing flow using FIG. 13.

Step 1:

The user operates the terminal and inputs a natural language request together with optional profile information. The terminal displays an input screen, receives text such as “I want to do FA, but I don't know which department is suitable for me.” and may retrieve stored skill tags (for example “financial analysis basics, spreadsheet operation, communication”) from local storage.

Input: user's natural language text and user profile data.

Output: a structured request object containing a user identifier, a request string, and a list of skills.

The terminal converts the input into a structured internal format and prepares it for network transmission.

Step 2:

The terminal sends the structured request object to the server. The terminal encapsulates the user identifier, the request string, and the skill list into a message and transmits it over a communication network using a request protocol.

Input: structured request object generated in Step 1.

Output: a network message delivered to the server.

The terminal performs serialization of the request object into a text-based format and writes the serialized data into the network socket.

Step 3:

The server receives the network message and stores the request as record information. The server parses the message, extracts the user identifier, the request string, and the skill list, and inserts a new record into a request table in the information storage device.

Input: network message from the terminal.

Output: a stored request record and an in-memory representation of the request.

The server performs data validation, normalizes the text encoding, and writes the validated values into the database tables.

Step 4:

The server generates a first prompt sentence for a generative AI model based on the request string and the user skills. The server constructs a text template and embeds the request string and the skill list to form a prompt sentence such as:

“User request: ‘I want to do FA, but I don't know which department is suitable for me.’

User skills: financial analysis basics, spreadsheet operation, communication.

Task:
1. Identify the main intent of the user.
2. Identify the desired activity or department.
3. List key skills and interests implied by the request.

Output format:

intent: . . .

target_activity: . . .

key_skills: . . .

key_interests: . . . ”

Input: request string and user skill list from Step 3.

Output: a first prompt sentence to be sent to the generative AI model.

The server concatenates predefined template segments and variable parts, and verifies that the prompt sentence follows a constrained output specification.

Step 5:

The server sends the first prompt sentence to the generative AI model and receives structured information. The server transmits the prompt sentence to an inference service hosting a transformer-based model and waits for the response text. The model processes the input tokens through attention and feed-forward layers and returns text containing “intent”, “target_activity”, “key_skills”, and “key_interests”.

Input: first prompt sentence generated in Step 4.

Output: response text from the generative AI model.

The server receives the text, applies pattern matching to locate labels and values, and converts the text into a structured data object containing intent, target activity, and lists of skills and interests.

Step 6:

The server normalizes the structured information and derives query parameters. The server maps the “target_activity” to one or more internal department categories and maps each “key_skill” to a canonical skill identifier using a skill normalization table.

Input: structured data object from Step 5.

Output: normalized department category identifiers and normalized skill identifiers.

The server performs table lookups in the information storage device, applies string similarity checks and predefined mapping rules, and produces a set of query parameters for database searching.

Step 7:

The server queries the information storage device for department information based on the derived parameters. The server generates a query expression that selects departments whose required skills intersect with the normalized skill identifiers and whose category matches the target activity.

Input: normalized department category identifiers and skill identifiers from Step 6.

Output: a set of department records retrieved from the database.

The server executes the query against the department-related tables, joins department records with required skill records, and returns a collection of rows describing candidate departments.

Step 8:

The server optionally queries the information storage device for person information associated with the candidate departments. The server uses the identifiers of the candidate departments to select persons affiliated with those departments and having overlapping skill or interest tags with the user.

Input: candidate department identifiers from Step 7 and user skill or interest identifiers.

Output: a set of person records associated with the candidate departments.

The server executes a second query over person and affiliation tables, calculates intersections of skill and interest tags, and produces person records that satisfy a minimum overlap threshold.

Step 9:

The server computes a suitability index for each candidate department. The server compares each department's required skill set with the user's skill set. The server counts matching skills, multiplies each match by a weight from a skill weight table, and divides by a normalization factor reflecting the number of required skills.

Input: department records from Step 7 and user skill identifiers from Step 6.

Output: suitability indices for the candidate departments.

The server performs vector-like operations, constructs numerical feature vectors for departments and the user, and evaluates a scoring function that returns a numeric suitability value for each department.

Step 10:

The server computes a suitability index or relevance score for each person candidate. The server compares each person's skill and interest tags with the user's tags, counts overlaps, and optionally applies a weighting scheme that prioritizes shared interests.

Input: person records from Step 8 and user skill and interest identifiers from Step 6.

Output: suitability or relevance scores for the person candidates.

The server executes set intersection operations and simple arithmetic computations to derive a scalar score representing the strength of the match between the user and each person.

Step 11:

The server ranks and filters the department and person candidates based on the computed indices. The server sorts departments in descending order of suitability index and discards those below a threshold. The server performs a similar sorting operation for persons and optionally limits the number of displayed candidates.

Input: suitability indices for departments from Step 9 and suitability or relevance scores for persons from Step 10.

Output: ranked lists of department candidates and person candidates.

The server applies comparison operations and stable sorting algorithms to order the candidates, then truncates the lists to a predetermined maximum size.

Step 12:

The terminal or the server acquires state information related to the user's emotional state. The terminal collects sensor-derived features such as typing speed, voice characteristics, or facial expression features, and sends them to the server together with user-entered mood indicators. The server receives these features and aggregates them into a feature vector.

Input: sensor-derived features and user-entered mood indicators.

Output: an aggregated feature vector representing user state.

The server normalizes numeric values, encodes categorical indicators, and constructs a fixed-length vector that can be input to a classification model.

Step 13:

The server analyzes the emotional state of the user using the aggregated feature vector. The server inputs the vector into an emotional state classification model, which may be a neural network or a statistical classifier, and obtains a label such as “confused”, “confident”, or “stressed”, together with a confidence score.

Input: aggregated feature vector from Step 12.

Output: an emotional state label and a confidence score.

The server performs matrix multiplications and activation function evaluations defined by the classification model, evaluates a softmax or similar output function, and selects the label with the highest probability.

Step 14:

The server generates a second prompt sentence for the generative AI model that incorporates recommendation data and the emotional state. The server constructs a prompt sentence such as:

“User skills: financial analysis basics, spreadsheet operation, communication.

Candidate departments and suitability scores:
Corporate Finance Department: score 0.86
Business Planning Department: score 0.74

User emotional state: confused, low confidence.

Task:

Explain to the user, in simple and reassuring language, why the Corporate Finance Department is the most suitable choice.

Highlight the user's strengths and suggest one or two concrete next steps to prepare for this department.”

Input: ranked lists of department candidates and person candidates from Step 11, user skill information from Step 6, and emotional state information from Step 13.

Output: a second prompt sentence to be sent to the generative AI model.

The server formats the candidate lists into text, embeds the emotional state label, and appends explicit instructions that control the tone and structure of the expected explanation.

Step 15:

The server sends the second prompt sentence to the generative AI model and receives an explanatory text. The generative AI model processes the input text tokens and generates an output sequence describing why certain departments are suitable and what actions the user should take.

Input: second prompt sentence generated in Step 14.

Output: explanatory text generated by the generative AI model.

The server transmits the prompt to the model, receives the generated text, and performs minimal post-processing such as trimming whitespace and checking for required sections.

Step 16:

The server assembles the final recommendation content and output data for the terminal. The server combines the ranked department candidates, the person candidates, the suitability indices, and the explanatory text into a structured response object.

Input: ranked candidates from Step 11 and explanatory text from Step 15.

Output: a response object containing recommendation content and explanatory text.

The server serializes the response object into a transmission format and associates metadata such as timestamps and identifiers for logging and traceability.

Step 17:

The server sends the response object to the terminal. The server writes the serialized data into the network interface and transmits it through the communication network to the terminal associated with the user.

Input: serialized response object from Step 16.

Output: a network message containing recommendation results delivered to the terminal.

The server may also record a summary of the sent recommendations in a log table for later analysis or evaluation.

Step 18:

The terminal receives the recommendation results and presents them to the user. The terminal parses the response object, extracts the list of recommended departments, associated suitability indices, person candidates, and the explanatory text, and renders them on the display or through audio output.

Input: network message from the server containing recommendation results.

Output: visual and/or auditory presentation of the recommendations to the user.

The terminal constructs user interface elements such as lists, detail views, and text areas, populates them with the received data, and updates the screen so that the user can review and interact with the recommendations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional recommendation systems and matching systems that operate in enterprise environments typically rely on rigid rule-based filters or static machine learning models that evaluate only structured data stored in databases. Such systems generally process user requests by mapping predefined request types to fixed queries, without deeply understanding free-form natural language inputs or dynamically adapting to the user's current emotional state. As a result, these systems often fail to generate sufficiently accurate or context-aware recommendations for organizational units, work assignments, or persons, particularly when user requests are expressed in natural language and contain implicit constraints, nuanced preferences, or emotional intent.

Further, existing architectures that incorporate natural language processing and machine learning generally treat these components as independent modules. Natural language understanding components may extract intent and entities, while separate recommendation engines score candidates using static features. However, these architectures do not systematically integrate (i) semantic information extracted from natural language requests, (ii) structured profile and activity data from databases, (iii) an emotion profile derived from multimodal user inputs, and (iv) a generative AI model controlled via a precisely constructed prompt sentence. In many cases, when a generative AI model is used, it is invoked in an ad-hoc manner with loosely specified prompts, without a standardized pipeline to construct prompts from verified candidate sets and emotion profiles, and without a feedback loop to validate and refine the model's outputs against authoritative data stores.

Moreover, conventional systems invoking generative AI models rarely perform robust post-processing and validation of the model's textual outputs against a database of record. Recommendations produced by generative AI models may refer to non-existent entities, outdated resources, or candidates that do not satisfy operational constraints, leading to unreliable or unsafe recommendations. In addition, these systems often lack mechanisms for capturing user feedback in a structured way and using that feedback to continuously adapt prompt generation strategies and candidate selection models, resulting in stagnation of recommendation quality over time.

Accordingly, there is a need for an improved computer-implemented technique that tightly integrates natural language processing, emotion analysis, structured data retrieval, similarity-based candidate selection, and generative AI models under prompt sentence control, with systematic validation against a storage device and learning from user feedback. Such a technique should (i) transform free-form user requests into rich semantic and emotional representations, (ii) generate candidate sets from structured data via machine learning-based similarity measures, (iii) construct context-aware prompt sentences that bind the generative AI model to those verified candidates and emotion profiles, and (iv) verify and refine the generative AI outputs before presenting them to the user. By improving the way in which the processor orchestrates these computational steps, the overall functioning of the computer system can be enhanced in terms of accuracy, robustness, adaptability, and efficiency of recommendation processing.

The specific processing by the specific processing unit 290 of the data processing device 12 in Application Example 2 is realized by the following means.

The present invention provides a server comprising a processor and a storage device, the processor being configured to aggregate, into the storage device, attribute information of users and activity information of organizational units, to perform natural language preprocessing on request sentences acquired from user terminals in order to extract semantic information such as request type, required capabilities, hobbies or interests, and constraint conditions, to select candidate organizational units, work units, or persons on the basis of the extracted semantic information and the attribute information of a user by using similarity calculation algorithms and machine learning models, to perform emotion analysis on input text, voice information, or image information in order to generate an emotion profile representing an emotional state of the user, to generate a prompt sentence in natural language that includes at least the candidate information, the emotion profile, and the semantic information as an instruction text to be input into a generative AI model, to input the prompt sentence into the generative AI model in order to cause the generative AI model to generate response data specifying at least one of the organizational units, work units, or persons and including a reason for the specification, to extract identification information of the specified entities from the response data and verify existence, availability, and condition conformity of those entities against the storage device in order to determine final recommendation targets, to generate result information for presentation to the user terminals on the basis of the final recommendation targets and the reasons output by the generative AI model, and to store evaluation or feedback information on the result information in the storage device and update at least one of the prompt sentence generation process and the candidate selection process on the basis of the evaluation or feedback information. This enables the computer system to more accurately and reliably transform free-form natural language and multimodal user inputs into validated, context-aware recommendations, to reduce erroneous or inconsistent outputs from the generative AI model by constraining and verifying model responses against authoritative data, and to continuously improve recommendation performance through feedback-driven adaptation of prompt construction and candidate modeling, thereby improving the overall functioning of the underlying computer technology.

The term “user” refers to an individual or entity that issues a request to the system through a user terminal and receives recommendation results from the system.

The term “organizational unit” refers to any logical or physical subdivision within an organization, including but not limited to a department, team, group, project unit, or similar entity having defined activities or responsibilities.

The term “work unit” refers to a unit of work to be performed, including but not limited to a task, job, assignment, operation, process step, or project activity that can be allocated to a user.

The term “person” refers to an individual associated with the organization, including but not limited to an employee, member, collaborator, or participant whose information is stored in the storage device.

The term “attribute information” refers to information describing properties of a user or person, including but not limited to skills, capabilities, qualifications, experience, roles, hobbies, interests, and historical activity data.

The term “activity information” refers to information describing properties of an organizational unit or work unit, including but not limited to required capabilities, responsibilities, tasks, workflows, constraints, and contextual conditions.

The term “storage device” refers to any computer-readable memory or data storage apparatus, including but not limited to a database system, file system, or other persistent storage in which attribute information, activity information, logs, and models are recorded and managed.

The term “user terminal” refers to any computing apparatus operated by a user to interact with the system, including but not limited to a desktop computer, portable computer, handheld device, wearable device, or other communication-capable interface.

The term “natural language request sentence” refers to a text string or speech-derived text that is expressed in a human language and describes a user's request, intention, preference, or question to be processed by the system.

The term “natural language processing technique” refers to a computational method or algorithm for processing natural language data, including but not limited to tokenization, syntactic analysis, semantic parsing, intent detection, and entity extraction.

The term “semantic information” refers to structured data derived from a natural language request, including but not limited to a request type, required capabilities, hobbies or interests, constraint conditions, and other meaning-bearing elements.

The term “request type” refers to a classification of a user request, including but not limited to a request for assignment, transfer, person search, task recommendation, or information retrieval.

The term “required capability” refers to a skill, qualification, or competency that is necessary or preferred for a particular organizational unit or work unit.

The term “hobby or interest” refers to a non-mandatory preference or topic that a user or person enjoys or is inclined toward, including but not limited to sports, leisure activities, academic fields, or thematic interests.

The term “constraint condition” refers to a limitation or requirement associated with a user request, including but not limited to location, time, workload, eligibility, or policy-based constraints.

The term “similarity calculation algorithm” refers to a computational method for quantifying similarity between data items, including but not limited to vector-based similarity metrics, distance functions, and matching scores.

The term “machine learning model” refers to a computational model trained on data to infer patterns or predictions, including but not limited to classification models, regression models, embedding models, and neural network-based matching models.

The term “candidate information” refers to information describing potential recommendation targets, including but not limited to identification information, attribute information, similarity scores, and other metadata for organizational units, work units, or persons.

The term “identification information” refers to data used to uniquely or distinctively reference an entity within the system, including but not limited to an identifier, code, or name associated with a user, organizational unit, work unit, or person.

The term “emotion analysis” refers to a computational process for determining an emotional state from user input, including but not limited to sentiment analysis, affect recognition, and classification of emotions based on text, voice, or image data.

The term “emotion profile” refers to structured data representing the emotional state of a user, including but not limited to labels such as happiness, anxiety, motivation, or quantitative scores corresponding to emotional dimensions.

The term “generative AI model” refers to a machine learning model configured to generate output data, such as text, in response to input data, including but not limited to language models that produce natural language responses based on a prompt.

The term “prompt sentence” refers to a natural language instruction text generated by the processor and provided as input to the generative AI model, the text specifying context, constraints, candidate information, emotion profile, and requested output behavior.

The term “response data” refers to data generated by the generative AI model in response to a prompt sentence, including but not limited to recommended entities, explanatory text, and structured fields indicating reasons or confidence.

The term “verification process” refers to a computational procedure for checking entities referenced in the response data against the storage device to confirm existence, availability, and conformity to constraint conditions.

The term “existence” refers to whether an entity referenced by response data has a corresponding record in the storage device.

The term “availability” refers to whether an entity referenced by response data is currently usable or assignable under operational conditions, including but not limited to capacity, schedule, and status.

The term “condition conformity” refers to whether an entity referenced by response data satisfies applicable constraint conditions, including but not limited to skill requirements, policy rules, and context-specific limitations.

The term “final recommendation target” refers to one or more entities selected after the verification process as valid and suitable recommendation results to be presented to the user.

The term “result information” refers to data formatted for presentation to the user, including but not limited to the final recommendation targets, their identification and attributes, and reasons for recommendation derived from the generative AI model.

The term “evaluation information” refers to structured data representing the user's assessment of the result information, including but not limited to ratings, selections, acceptance or rejection, and evaluation scores.

The term “feedback information” refers to additional information provided by the user regarding the result information or system behavior, including but not limited to comments, corrections, or preferences, used to adjust system processing.

The term “learning process” refers to a procedure in which the system modifies one or more models, parameters, or rules used in prompt sentence generation or candidate selection on the basis of evaluation information or feedback information.

The term “prompt sentence generation process” refers to a sequence of computational steps by which the processor constructs a prompt sentence for the generative AI model from semantic information, candidate information, and the emotion profile.

The term “candidate selection process” refers to a sequence of computational steps by which the processor selects candidate organizational units, work units, or persons from the storage device using similarity calculation algorithms and machine learning models.

In one embodiment, a server, a plurality of terminals, and users cooperate to implement the claimed system. Server comprises at least one processor, a main memory, a non-transitory storage device, and a network interface. Server executes an operating system such as a general-purpose server operating system and an application program implementing a natural language processing module, an emotion analysis module, a candidate selection module, a prompt generation module, and an interface module to a generative AI model. Server further manages a relational database system, such as a general-purpose relational database management system, as the storage device for user attribute information and organizational activity information.

Terminal comprises a communication unit, a display unit, one or more input units (keyboard, touch panel, microphone, camera), and a local processor that executes client software. User operates terminal to transmit request sentences and feedback to server and to receive recommendation results from server. Terminal runs a web browser, a native application, or a wearable device application, and communicates with server through a network using standardized protocols such as HTTPS.

Server stores, in the storage device, user attribute information and organizational activity information as structured records. Server represents user attribute information in tables such as a user table having fields for a user identifier, skill descriptors, experience descriptors, hobby or interest descriptors, current affiliation identifiers, and historical interaction records. Server represents activity information of organizational units and work units in tables such as an organizational unit table and a work unit table having fields for an organizational unit identifier or work unit identifier, required capability descriptors, activity descriptions, operational constraints, and current availability flags. Server additionally stores person records representing individuals as potential recommendation targets.

Server executes a natural language processing module that is implemented in a high-level language such as a scripting language and that uses a text processing library such as a tokenization and syntactic analysis library and a contextual language representation model (for example, a transformer-based encoder) to process each natural language request sentence received from terminal. Server converts the request sentence into a sequence of tokens, applies part-of-speech tagging, and generates a contextual embedding vector for each token. Server further applies an intent classification submodel that outputs a categorical distribution over request types such as assignment request, transfer request, person search request, and work unit recommendation request. Server also applies a slot extraction submodel that identifies spans corresponding to required capabilities, hobbies or interests, constraint conditions, and other semantic items. Server aggregates these outputs into semantic information stored in an internal data structure including fields for request type, capability list, hobby list, constraint list, and free-form context text.

Server executes an emotion analysis module that processes input text, and optionally voice-derived features or image-derived features, to obtain an emotion profile for the user. In one embodiment, server applies a text-based emotion classifier implemented as a neural network having an embedding layer, one or more bidirectional recurrent layers or transformer layers, and a final dense layer outputting a vector of emotion scores such as joy, anxiety, motivation, boredom, and curiosity. In another embodiment, server additionally uses acoustic features (such as pitch and energy contours) and facial features extracted from images to form a multimodal feature vector, and applies a multimodal fusion network to estimate the emotion profile. Server normalizes and stores the emotion profile as a structured record associated with the corresponding request identifier and user identifier.

Server executes a candidate selection module that integrates the semantic information, the attribute information, and the activity information. Server represents skill descriptors, required capability descriptors, and hobby or interest descriptors as numerical vectors using an embedding model trained offline. For example, server uses a transformer-based encoder to map textual descriptions of skills and activities into a fixed-dimensional vector space. Server then computes similarity scores between a user skill vector and each organizational unit or work unit vector by applying a similarity calculation algorithm such as cosine similarity or dot product. Server filters out organizational units and work units whose similarity scores or required capability thresholds do not meet predefined criteria, thereby generating candidate information that lists candidate identifiers, corresponding similarity scores, and associated attributes.

Server executes a similar process for person candidates. Server represents each person's hobby or interest descriptors and capability descriptors as vectors in the same or a related embedding space, and computes similarity between the requesting user's attributes and other persons'attributes. Server optionally conditions this similarity computation on the emotion profile by weighting dimensions associated with social or enjoyment-related attributes when the emotion profile indicates a desire for enjoyment, thereby producing emotion-aware similarity values. Server then selects a subset of person records as candidates for matching.

Server executes a prompt generation module that constructs a prompt sentence for a generative AI model. Server concatenates static instruction phrases, structured semantic information, candidate information, and the emotion profile into a single natural language text. Server formats the prompt sentence to constrain the behavior of the generative AI model so that the model operates only on candidates that have already been validated at the database level, rather than generating arbitrary identifiers. For example, server generates a prompt sentence such as:

“You are a recommendation engine. Use the following information to recommend the best department for this user.

User request: ‘I want to do FA but I do not know which department is suitable. I want to enjoy FA.’

User skills: project management, data analysis, communication.

User emotion profile: joy high, anxiety low, motivation high.

Candidate departments with required skills:
1. Department A—required: communication, creativity, data analysis.
2. Department B—required: machine operation, quality inspection.
3. Department C—required: research skills, programming, analysis.

Recommend the most suitable department and explain briefly why.”

In another case, server generates a prompt sentence such as:

“Recommend the best factory task for this user based on the following data.

User skills: machine operation level 3, basic maintenance.

User emotion: wants a challenge, motivation high, boredom risk high.

Available tasks:
1. Task 1—routine operation, low difficulty.
2. Task 2—setup and optimization, high difficulty, requires machine operation level 3.
3. Task 3—quality check helper, medium difficulty.

Choose the most suitable task and give a short explanation.”

In yet another case, server generates a prompt sentence such as:

“You are helping with internal networking.

User request: ‘I want to gather people in headquarters who like baseball but I do not know who they are.’

Candidate employees in headquarters with hobby=baseball:
1. Person A—organizational unit: sales.
2. Person B—organizational unit: human resources.
3. Person C—organizational unit: information technology.

Present a concise list of recommended people and a friendly explanation.”

Server provides the prompt sentence as input to a generative AI model. In one embodiment, server invokes an external large language model service through an application programming interface. In an alternative embodiment, server executes an internal generative AI model implemented as a transformer-based decoder network. In the internal model, server stores model parameters in the storage device and loads them into memory at runtime. Server processes the prompt sentence token by token through multiple attention layers, with each layer computing self-attention scores and updated token representations. Server controls inference parameters such as temperature and maximum output length to control determinism and verbosity.

Server parses the response data produced by the generative AI model. Server identifies in the output text the recommended entity identifiers or names, as well as the textual reasons for recommendation. To reduce ambiguity, server instructs the generative AI model in the prompt sentence to output identifiable labels matching candidate identifiers. Server uses regular expressions, token-level analysis, or an auxiliary classifier to extract the identifiers. Server then executes a verification process in which server queries the storage device to confirm that each referenced entity exists, is currently available, and satisfies constraint conditions. For example, server retrieves the availability status and constraint fields from the organizational unit table or work unit table, and compares them with the request constraints and emotion profile. If a recommended entity does not satisfy constraints or is not found, server discards that entity and optionally selects an alternative candidate based on similarity scores or requests a revised response by generating a modified prompt sentence that excludes invalid entities.

Server generates result information for presentation to terminal. Server constructs a data structure containing the final recommendation targets, associated identifiers, attribute summaries, similarity scores, and explanation text from the generative AI output. Server then serializes this structure into a response format and transmits it to terminal through the network interface. Terminal receives the response, parses it, and renders the recommendation on the display unit. For example, terminal presents the name of a recommended organizational unit, its main activities, a summary of required capabilities, and a short explanation such as “This department best matches your skills and your desire to enjoy FA.”User reviews the displayed result information and optionally provides evaluation or feedback. Terminal collects a rating, a selection, or a comment from user and sends this feedback back to server. Server stores feedback information in association with the corresponding request and recommendation record. Server periodically or incrementally updates the parameters of the candidate selection models and the prompt generation rules based on aggregated feedback. For example, server adjusts similarity thresholds, modifies weighting factors in the similarity calculation for certain emotion states, or refines instruction phrases within the prompt sentence to reduce ambiguous outputs. Server may perform supervised fine-tuning of the semantic extraction model or the internal generative model by minimizing a loss function measuring deviation between produced recommendations and feedback-labeled desired outputs, updating model weights through gradient-based optimization.

Server thereby improves the internal functioning of the computer system. By constructing prompt sentences that explicitly encode semantic information, candidate sets, and emotion profiles, server constrains the generative AI model's search space and reduces generation of inconsistent or non-existent entities. This results in fewer database lookups to correct erroneous outputs and decreases communication overhead between server and terminals. By pre-filtering candidates with vector-based similarity and constraint checks before calling the generative AI model, server reduces computational load on the model and shortens response latency. By integrating feedback-driven updates to both candidate selection and prompt generation, server continuously adapts its internal models and rules to improve recommendation accuracy and stability over time, leading to a technical improvement in recommendation processing performance compared to static or purely rule-based systems. Server uses data structures tailored for efficient computation. For example, server stores embedding vectors for skills and activities in a separate vector store indexed by user identifiers and organizational unit identifiers. Server uses approximate nearest neighbor search algorithms to quickly retrieve top-k similar vectors, thereby improving scalability as the number of users and organizational units grows. Server stores emotion profiles as compact fixed-length vectors to allow fast arithmetic operations and efficient conditioning of similarity calculations. These structural choices reduce memory bandwidth usage and improve cache locality, which contributes to higher throughput of the overall system.

In another embodiment, server implements different architectures and training methods for the generative AI model. Server may use an encoder-decoder architecture in which an encoder processes the structured candidate information and emotion profile to form a context representation, and a decoder generates the textual recommendation conditioned on this representation and the prompt sentence. Server trains the encoder-decoder model on historical request-recommendation pairs stored in the storage device, using a loss function such as cross-entropy between predicted tokens and ground truth tokens. Server applies regularization methods, data augmentation (for example, paraphrasing of requests and varying candidate lists), and early stopping to avoid overfitting. Server may separately train an auxiliary classifier to predict ranking scores for candidates from intermediate encoder states, further enhancing the ability to generate high-quality recommendations.

In yet another embodiment, server varies the composition of the prompt sentence, for example by including explicit labels for fields (“RequestType: assignment”, “RequiredSkills: . . . ”, “EmotionProfile: . . . ”) to help the generative AI model parse the input deterministically. This structured prompting approach reduces ambiguity and increases the repeatability of results, which provides a technical effect in the form of reduced variance and improved predictability of system behavior. Server can further compress candidate lists for transmission by encoding them as concise identifiers in the prompt sentence and maintaining an internal mapping to full records, thereby reducing the length of the prompt sentence and lowering network and computation costs during interaction with the generative AI model.

Terminal may also be implemented as a wearable device such as smart glasses. In this case, terminal receives recommendation results from server and displays them as an overlay in the user's field of view, enabling real-time assistance in environments such as physical workplaces or retail spaces. The use of the described internal data processing improves the timeliness and reliability of on-device display, because server has already filtered and validated entities before they are sent to terminal, thereby reducing the need for additional checks on the wearable device, which may have limited computational resources.

Through these embodiments, server, terminal, and user cooperatively implement a system that not only automates a class of recommendation tasks but also changes the internal operation of the computer system by introducing a specific combination of semantic extraction, vector-based candidate selection, emotion profiling, constrained prompt sentence generation, generative AI inference, and post-verification, thereby yielding concrete technical effects such as increased recommendation precision, reduced erroneous outputs, lower latency, and improved resource utilization.

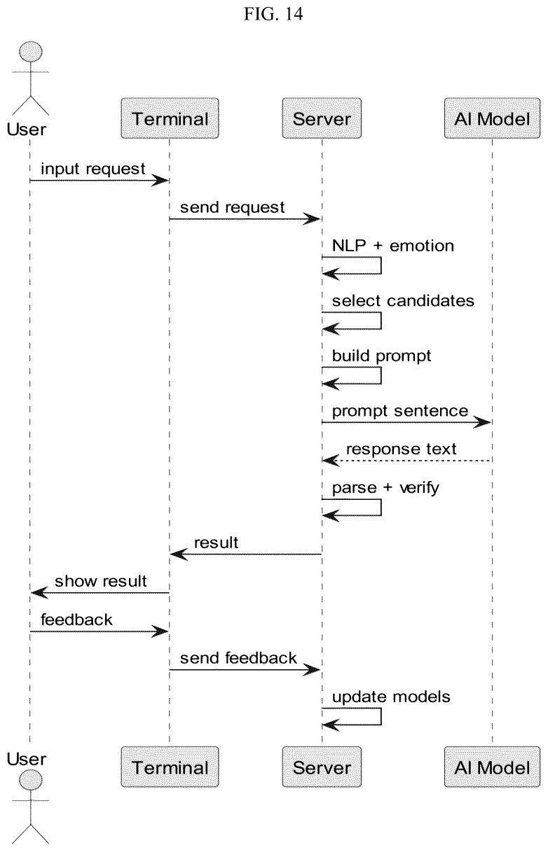

The following describes the processing flow using FIG. 14.

Step 1:

User operates the terminal to input a natural language request.

User types or speaks a request such as “I want to do FA but I do not know which department is suitable. I want to enjoy FA,” “Recommend a new factory task that uses my machine operation skills,” or “I want to gather people in headquarters who like baseball.”

Input: free-form natural language text (or speech) and optional explicit preferences or emotions.

Output: raw request text and associated user identifier, ready to be sent to the server.

Step 2:

Terminal acquires the user's input and prepares a transmission payload.

Terminal converts speech to text using a speech recognition function if the user provided voice input, and may also acquire sensor data such as audio features or facial images if available. Terminal bundles the text, user identifier, device context (e.g., location, device type), and optional sensor metadata into a structured payload.

Input: raw text from user, optional audio data, optional image data, user identifier.

Output: structured request payload (for example, a record with fields {user_id, request_text, sensor_metadata}) transmitted to the server over a network.

Step 3:

Server receives the request payload and logs it.

Server accepts the payload via a network interface, authenticates the user, and extracts the request text, user identifier, and context fields. Server writes a new entry to a request log table in the storage device to record the timestamp, the raw request text, and the user identifier.

Input: structured request payload from terminal.

Output: log record stored in a request log and an in-memory representation of the request used for subsequent processing.

Step 4:

Server retrieves user attribute information and organizational activity information from the storage device.

Server executes database queries to obtain the user's stored skills, experience, hobbies, interests, and historical activity, and to obtain organizational unit and work unit records including required capabilities, activity descriptions, and constraint fields. Server joins or aggregates these records into internal data structures representing the user profile and the full set of potential targets.

Input: user identifier and request context from the log record.

Output: user profile data and collections of candidate organizational units, work units, and persons, represented as structured records in memory.

Step 5:

Server performs natural language preprocessing on the request text.

Server applies a natural language processing pipeline that tokenizes the text, performs part-of-speech tagging, and generates contextual embeddings using a language model. Server runs an intent classifier to determine whether the request is an assignment request, a transfer request, a person search request, or another supported request type, and runs a slot extractor to identify phrases corresponding to required capabilities, hobbies or interests, and constraint conditions.

Input: raw request text.

Output: semantic information including request type, capability list, hobby or interest list, constraint list, and residual context text.

Step 6:

Server performs emotion analysis to generate an emotion profile.

Server uses at least the text of the request and, when available, features derived from audio or image data to compute an emotion vector. Server feeds embeddings of the text and optional multimodal features into an emotion classifier neural network and obtains scores for emotion categories such as joy, motivation, anxiety, and boredom. Server normalizes these scores and stores them as an emotion profile associated with the current request.

Input: request text and optional sensor-derived features.

Output: emotion profile containing numeric or categorical representations of the user's emotional state.

Step 7:

Server encodes user attributes and activity requirements into numerical vectors.

Server converts skill descriptors, required capability descriptors, and hobby or interest descriptors into vectors using a pre-trained embedding model. Server applies the embedding model to each relevant text field (e.g., “machine operation level 3,” “quality inspection”) to obtain fixed-length vectors, and stores these vectors in memory or in a vector store aligned with entity identifiers.

Input: user profile data and organizational activity records.

Output: sets of embedding vectors representing user attributes and candidate attributes ready for similarity computation.

Step 8:

Server calculates similarity scores and selects candidates.

Server computes similarity between the user's attribute vectors and each organizational unit, work unit, and person vector, using a similarity calculation algorithm such as cosine similarity. Server combines these similarity scores with constraint checks (e.g., location, availability, qualification thresholds) and emotion-aware weighting (e.g., giving higher weight to enjoyable tasks when the emotion profile indicates a desire for enjoyment). Server filters out entities that do not meet thresholds and constructs candidate lists ranked by similarity.

Input: user attribute vectors, candidate attribute vectors, constraint list, emotion profile.

Output: candidate information containing ranked lists of organizational units, work units, and persons with identifiers, attributes, and similarity scores.

Step 9:

Server constructs a prompt sentence for the generative AI model.

Server converts the semantic information, the candidate information, and the emotion profile into a natural language instruction. Server concatenates static instruction phrases with formatted lists of candidates and explicit field labels so that the generative AI model is constrained to operate only on the given candidates. Server includes the user's request sentence, summarized skills, and emotion profile to provide context.

Input: semantic information, candidate information, emotion profile.

Output: prompt sentence in natural language that encodes the context, candidates, and desired output behavior.

Step 10:

Server sends the prompt sentence to the generative AI model and obtains response data.

Server invokes a generative AI model—either internally hosted or accessed via an external interface—and provides the prompt sentence as input. Server configures inference parameters such as temperature and maximum token count to control determinism and length. The generative AI model processes the prompt sentence token by token and generates an output text that contains at least one recommended entity and an explanation.

Input: prompt sentence.

Output: generated response text including recommendations and reasons.

Step 11:

Server parses the response data to extract recommended entities and reasoning.

Server analyzes the generated text to identify references to candidate identifiers or names, using explicit labels included in the prompt and parsing rules such as regular expressions or token-level classification. Server segments the text into structured fields such as recommended entity identifiers and explanation text.

Input: generated response text from the generative AI model.

Output: structured response data including recommended entity identifiers and associated explanations.

Step pb 12:

Server verifies recommended entities against the storage device.

Server uses the extracted identifiers to query the database tables for organizational units, work units, and persons. Server checks that each recommended entity exists, is currently available, and satisfies the constraint conditions derived from the request. Server discards recommendations that fail these checks and, if necessary, selects alternative candidates from the ranked candidate lists prepared earlier or regenerates a prompt sentence excluding invalid entities.

Input: structured response data and storage records for recommended entities.

Output: validated list of final recommendation targets and associated explanations.

Step 13:

Server generates result information for presentation to the terminal.

Server builds a result data structure that contains the final recommendation targets, their identifiers, relevant attributes such as required capabilities or shared hobbies, similarity scores if desired, and the explanation text derived from the generative AI output. Server formats this data into a response message suitable for transmission to the terminal.

Input: validated recommendation targets and explanations.

Output: result information message containing structured recommendation data.

Step 14:

Terminal receives the result information and displays it to the user.

Terminal parses the result message and maps the fields to user interface elements. Terminal renders the recommended organizational units, work units, or persons on the display, showing names, brief descriptions, and explanations such as “This department best matches your skills and your desire to enjoy FA,” or “These three people share your interest in baseball.”

Input: result information message from server.

Output: visual or auditory presentation of recommendations to the user on the terminal.

Step 15:

User reviews the recommendations and optionally provides feedback.

User inspects the displayed information and may select one of the recommended options, request alternative recommendations, or provide explicit feedback such as a rating or comment (“This recommendation is appropriate,” “I prefer tasks with less travel,” etc.).

Input: displayed recommendation information.

Output: user actions and feedback data input into the terminal.

Step 16:

Terminal transmits user feedback to the server.

Terminal captures the selected options, rating values, and any textual comments, associates them with the corresponding request identifier, and sends them to server as a feedback payload.

Input: user feedback data and associated request identifier.

Output: feedback payload delivered to server.

Step 17:

Server stores feedback and updates internal models or parameters.

Server records the feedback payload in a feedback table linked to the original request and recommendation entries. Server periodically processes accumulated feedback to adjust thresholds for similarity scores, to refine the weighting of emotion dimensions in candidate selection, and to modify templates used for prompt sentence generation. Server may also use feedback-labeled data to retrain or fine-tune the semantic extraction model or the generative AI model, minimizing a loss function that measures disagreement between the generated outputs and desired outcomes.

Input: feedback payload and historical request-recommendation records.

Output: updated model parameters and configuration values that influence future candidate selection and prompt sentence generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

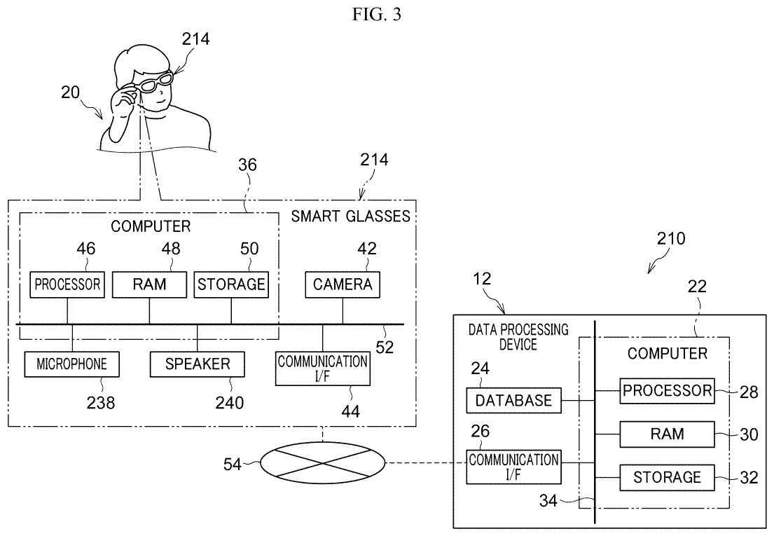

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

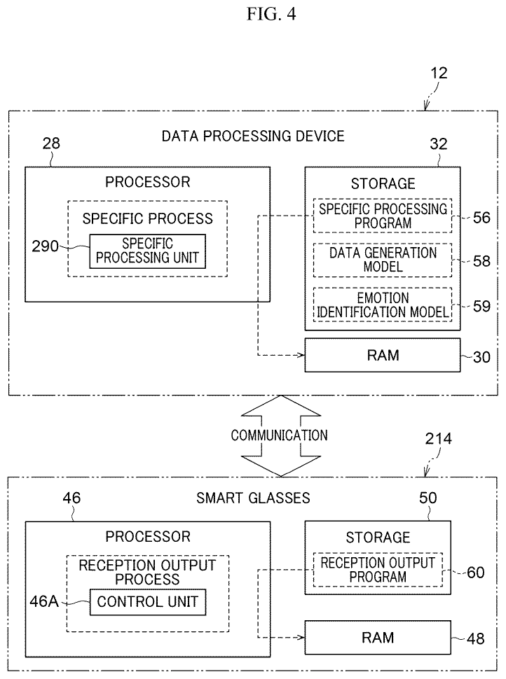

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

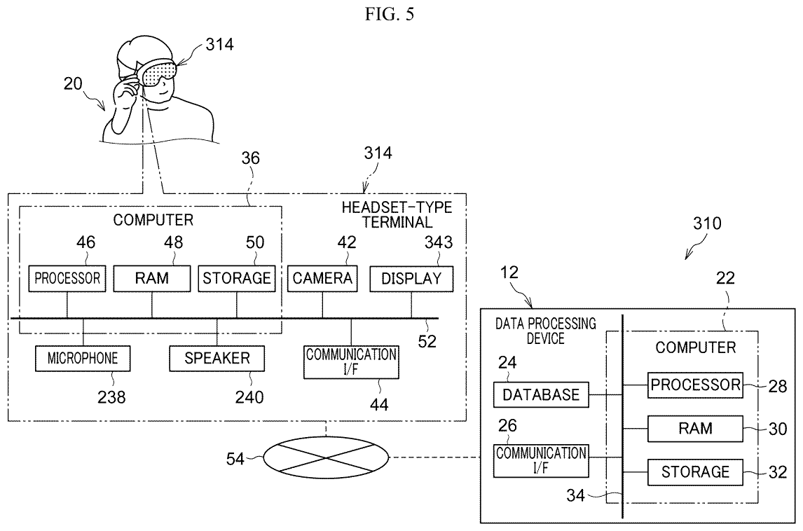

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

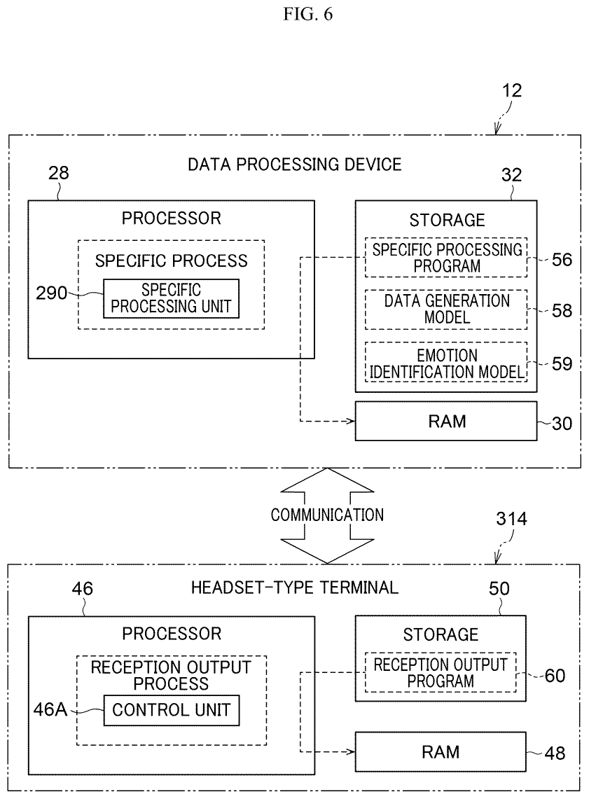

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

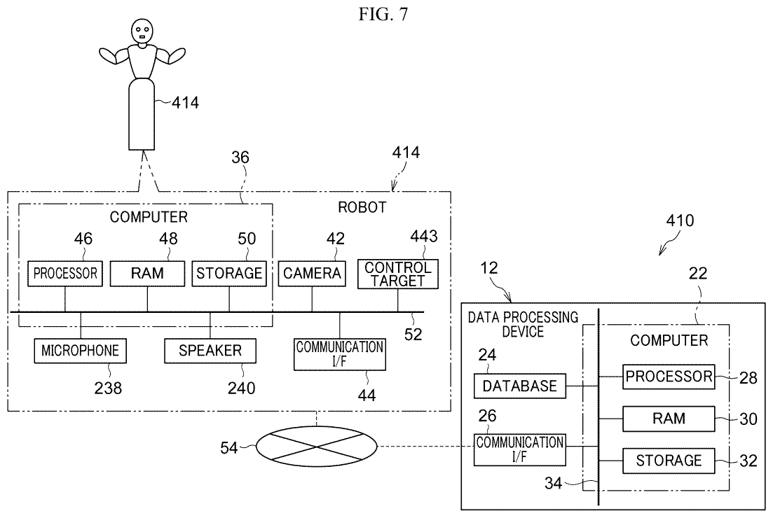

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

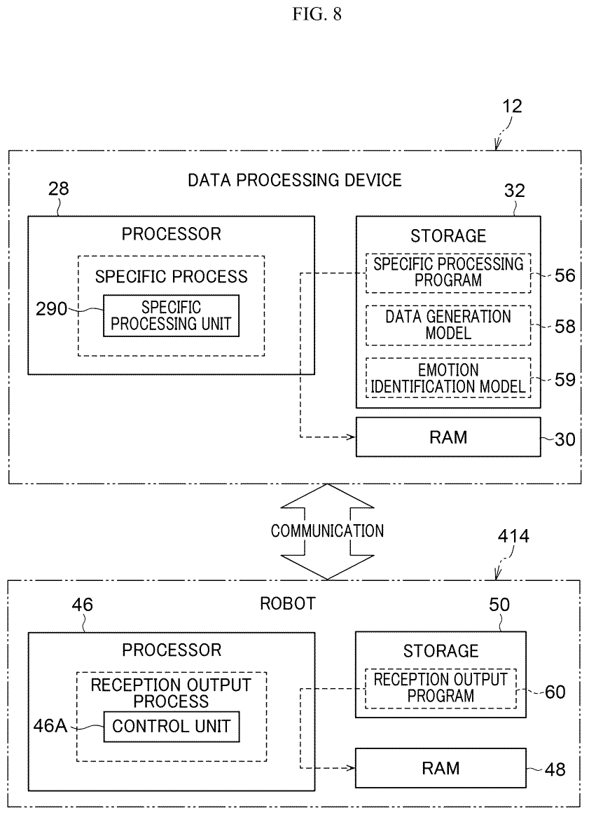

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

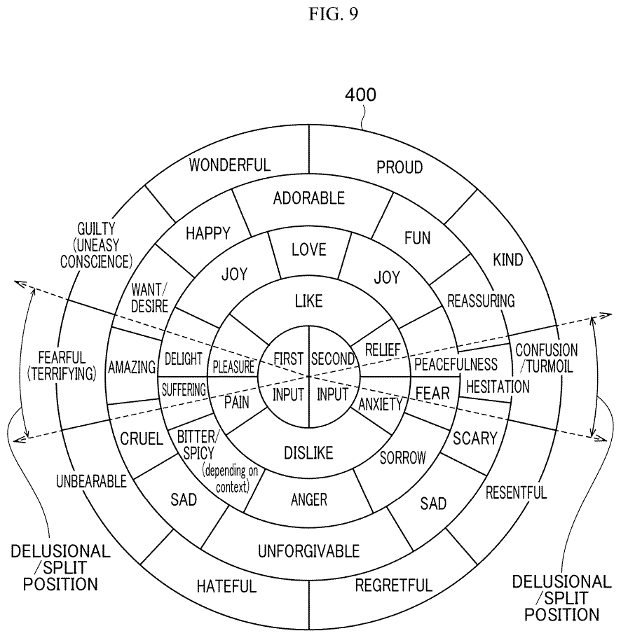

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

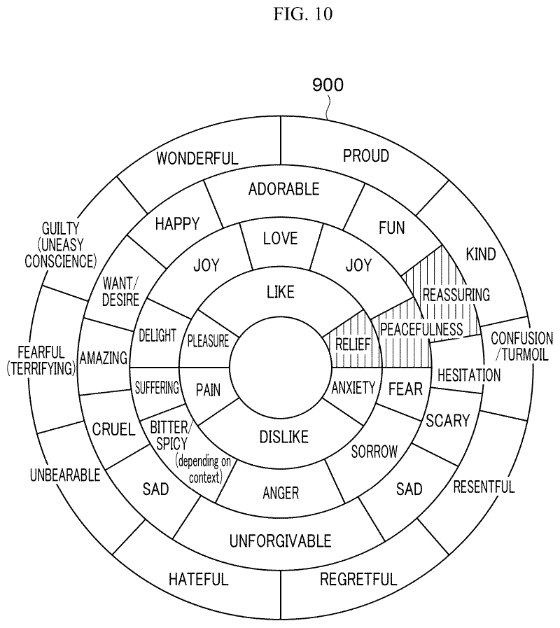

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to

collect and store attribute information of individual users and work content information of organizations in a relational database,

identify, based on specialty information, skill information, interest information, and preference information of the users stored in the relational database and work content information and required skill information of the organizations stored in the relational database, one or more organization candidates or work candidates suitable for each user by performing query processing using a query language,

generate a prompt sentence including at least the interest information and the preference information of the user and information regarding the identified organization candidates or work candidates, and input the prompt sentence to a generative AI model so as to cause the generative AI model to generate a proposal sentence related to the interest information and the preference information of the user,

store, in association, the proposal sentence generated by the generative AI model and the identified organization candidates or work candidates, and present the proposal sentence and the identified organization candidates or work candidates to the user, and

acquire operation history information or response information from the user via a terminal, and update at least one of generation conditions of the prompt sentence and identification conditions of the organization candidates or work candidates based on the operation history information or the response information.

### (Supplementary 2)

The system according to supplementary 1,

wherein the processor is configured to

cooperatively generate, based on the skill information of the user and the work content information stored in the relational database, search conditions for searching one or more departments or work units in which the user is to perform work and a prompt sentence to be input to the generative AI model, and present to the user the proposal sentence generated by the generative AI model together with the departments or the work units.

(Supplementary 3)

The system according to supplementary 1,

wherein the processor is configured to

estimate an emotional state of the user based on the attribute information of the user and the operation history information, dynamically change at least one of wording and level of detail of the prompt sentence to be input to the generative AI model in accordance with the emotional state and at least one of the interest information and the preference information, and cause the generative AI model to generate a proposal sentence adapted to the emotional state by inputting the changed prompt sentence to the generative AI model.

### Application Example 1

### (Supplementary 1)

A system comprising a processor,

wherein the processor is configured to

aggregate attribute information related to individual users and work-content information related to organizational units into a relational data management device, and to acquire the attribute information and the work-content information from the relational data management device based on identification information of a user and identification information of an organizational unit,

analyze the acquired attribute information and the acquired work-content information to compute, by arithmetic processing, a correspondence relationship between professional capabilities and preferences of the user and candidate work items executable in the organizational unit, select a work item suitable for the user from among the candidate work items, and generate, in a natural language, a prompt sentence including a selection result of the work item,

input the generated prompt sentence to a generative artificial intelligence model that performs natural language generation processing, acquire response information including work content to be assigned to the user from the generative artificial intelligence model, and extract task identification information and work-content information specified in the response information to format the task identification information and the work-content information as structured task information,

acquire, based on the structured task information, equipment identification information and control parameters associated with the work-content information, generate work instruction information including the equipment identification information and the control parameters, and transmit the work instruction information to an external terminal device via a communication network, and

record work progress information and work completion information transmitted from the terminal device in the relational data management device, and store a recording result as learning history information for use in subsequent generation of the prompt sentence and subsequent selection of the candidate work items.

### (Supplementary 2)

The system according to supplementary 1,

wherein the processor is configured to

extract explanation information regarding suitability of the candidate work items based on the response information acquired from the generative artificial intelligence model, and provide the explanation information to the terminal device in association with the work instruction information so as to present, to the user, a reason why the work item is assigned.

### (Supplementary 3)

The system according to supplementary 1,

wherein the processor is configured to

calculate performance indicators for each user based on the work progress information and the work completion information acquired from the terminal device, and add history information including the performance indicators to the prompt sentence to be input to the generative artificial intelligence model so as to optimize results of subsequent work assignment for the user.

### Example 2

### (Supplementary 1)

A system comprising a processor,

wherein the processor is configured to

receive, via a terminal, a natural language request and attribute information regarding a user, and to aggregate the request and the attribute information as record information in an information storage device,

generate, based on the request and the attribute information, a prompt sentence for input to a generative AI model, instruct the generative AI model by using the prompt sentence to extract structured information regarding an intention of the request and an ability of the user, and acquire the structured information from the generative AI model,

generate, based on a desired activity content and ability elements included in the structured information, a query command for an information storage device in which department information and person information are stored, and search the department information and the person information in accordance with the query command,

calculate, by using a general-purpose data processing program, a suitability index by comparing the department information and the person information acquired by the search with ability information of the user, and select department candidates and person candidates having a high suitability with respect to the user,

generate, based on the selected department candidates and person candidates, the suitability index, and the ability information of the user, an explanation prompt sentence for input to the generative AI model, and instruct the generative AI model by using the explanation prompt sentence to generate recommendation content and an explanatory text to be presented to the user, and acquire a generation result,

transmit the acquired recommendation content and the explanatory text to the terminal as output data, and cause the terminal to present the recommendation content and the explanatory text visually or aurally to the user, and

analyze an emotional state of the user based on input information from the user and state information obtained from a detection device, and include an analysis result in the prompt sentence and the explanation prompt sentence to be fed back to the generative AI model.

### (Supplementary 2)

The system according to supplementary 1,

wherein the processor is configured to generate, based on the desired activity content and the ability elements included in the structured information, a prompt sentence that instructs the generative AI model to search, from the information storage device, department information for each work unit, and to specify, in accordance with the prompt sentence, department candidates suitable for the user to perform work.

### (Supplementary 3)

The system according to supplementary 1,

wherein the processor is configured to generate, based on the analysis result of the emotional state of the user and interest content of the user, a prompt sentence that instructs the generative AI model to search, from the information storage device, person information of persons sharing specific interests or preferences, and to specify, in accordance with the prompt sentence, person candidates having interests in common with the user.

### Application Example 2

### (Supplementary 1)

A system comprising a processor and a storage device,

wherein the processor is configured to

aggregate attribute information of a user and activity information of an organizational unit into the storage device and generate structured data for querying the storage device,

perform preprocessing on a natural language request sentence acquired from a user terminal by using a natural language processing technique, and extract semantic information including a request type, a required capability, a hobby or interest, and a constraint condition,

select, on the basis of the extracted semantic information and the attribute information of the user, candidate organizational units, work units, or persons by using a similarity calculation algorithm and a machine learning model, and generate candidate information including identification information and attribute information of the candidates,

perform emotion analysis processing on input text, voice information, or image information of the user to generate an emotion profile representing an emotion state of the user, and hold the emotion profile in a format that is referable in subsequent processing,

generate a prompt sentence in a natural language as an instruction text for input to a generative AI model, the prompt sentence including at least the candidate information, the emotion profile, and the semantic information of the request,

input the prompt sentence to the generative AI model, and cause the generative AI model to generate response data that specifies at least one of the organizational units, the work units, or the persons on the basis of the candidate information and the emotion profile and includes a reason for the specification,

extract identification information of the specified organizational unit, work unit, or person from the response data, perform a verification process on the storage device to confirm existence, availability, and condition conformity, and determine a final recommendation target on the basis of a result of the verification process,

generate result information for presentation to the user terminal on the basis of the finally determined recommendation target and reason information output by the generative AI model, and transmit the result information to the user terminal, and

store evaluation information or feedback information on the result information, acquired from the user, in the storage device, and perform a learning process of updating a model or a parameter used in a prompt sentence generation process or a candidate selection process on the basis of the evaluation information or the feedback information.

### (Supplementary 2)

The system according to supplementary 1,

wherein the processor is configured to, when the request of the user is determined to be an assignment request or a transfer request, generate the prompt sentence including instruction content for searching, from the storage device, an organizational unit suitable for the user to perform work on the basis of capability information and the emotion profile of the user and activity information and required capability information of the organizational unit, and for recommending the organizational unit.

### (Supplementary 3)

The system according to supplementary 1,

wherein the processor is configured to, when the request of the user is determined to be a person search request and the emotion profile includes a positive emotion state, generate the prompt sentence including instruction content for searching, from the storage device, a person who shares a specific hobby or interest and has an emotion tendency consistent with the emotion profile, on the basis of hobby or interest information of the user, the emotion profile, and hobby or interest information of other members aggregated in the storage device.

What is claimed is:

1. A system comprising:
a communication interface coupled to a packet-switched network;
a storage device; and
circuitry configured to:
receive, via the communication interface, input data comprising a natural language request and attribute data associated with a requesting entity, and store the input data as record data in the storage device;
generate, based on the natural language request and the attribute data, a first prompt sentence and input the first prompt sentence to a generative neural network model to extract structured information comprising an intent classification and capability element data associated with the requesting entity;
generate, based on activity content data and the capability element data included in the structured information, a query command for the storage device in which entity profile data and classification-labeled reference data are stored, and execute a search of the entity profile data and the classification-labeled reference data in accordance with the query command;
compute, by a data processing program, a suitability index by comparing the entity profile data and the classification-labeled reference data obtained by the search with the attribute data, and select candidate data records having a suitability index exceeding a threshold;
generate, based on the selected candidate data records, the suitability index, and the attribute data, a second prompt sentence and input the second prompt sentence to the generative neural network model to generate recommendation output data and an explanatory text;
transmit the recommendation output data and the explanatory text to a terminal device via the communication interface; and
analyze a state of the requesting entity based on the input data and state information obtained from a detection device, and include an analysis result in at least one of the first prompt sentence and the second prompt sentence.

2. The system according to claim 1, wherein the circuitry is further configured to:
apply a tokenization process and contextual embedding generation to the natural language request using a language representation model to produce token-level embedding vectors; and
apply an intent classification submodel to the token-level embedding vectors to determine the intent classification from a plurality of predefined request type categories.

3. The system according to claim 2, wherein the circuitry is further configured to:
apply a slot extraction submodel to the token-level embedding vectors to identify spans corresponding to the capability element data, interest indicators, and constraint condition parameters; and
aggregate the intent classification, the capability element data, the interest indicators, and the constraint condition parameters into the structured information as a key-value data structure.

4. The system according to claim 3, wherein the circuitry is further configured to:
normalize the capability element data by mapping extracted text descriptors to canonical identifiers using a normalization table stored in the storage device; and
convert the canonical identifiers and reference data descriptors into fixed-dimensional numerical vectors using a pre-trained embedding model, the fixed-dimensional numerical vectors being stored in an indexed vector store.

5. The system according to claim 4, wherein the circuitry is further configured to:
compute cosine similarity between the fixed-dimensional numerical vectors representing the attribute data and fixed-dimensional numerical vectors representing each record in the classification-labeled reference data; and
combine the cosine similarity with constraint condition checks and a weighting adjustment conditioned on the analysis result of the state of the requesting entity to produce ranked candidate lists.

6. The system according to claim 5, wherein the weighting adjustment increases a weight assigned to interest-correlated dimensions of the fixed-dimensional numerical vectors when the analysis result indicates a positive emotional state, and decreases recommendation complexity when the analysis result indicates a fatigued or confused emotional state.

7. The system according to claim 1, wherein the first prompt sentence comprises a constrained output format specification that instructs the generative neural network model to return the structured information as labeled fields comprising at least an intent field, a target activity field, a capability list field, and an interest list field.

8. The system according to claim 7, wherein the circuitry is further configured to:
parse a response from the generative neural network model by applying pattern matching to extract values corresponding to the labeled fields; and
convert the extracted values into the structured information stored as an in-memory data structure accessible by the data processing program.

9. The system according to claim 8, wherein the circuitry is further configured to:
generate the query command as a parameterized database query that joins a first table storing the entity profile data with a second table storing required capability identifiers, the parameterized database query being conditioned on the capability element data and the target activity field extracted from the structured information.

10. The system according to claim 1, wherein the second prompt sentence includes at least a summary of the attribute data, a formatted list of the selected candidate data records with associated suitability index values, and the analysis result, and further includes an instruction portion that specifies a tone and a level of detail for the explanatory text conditioned on the analysis result.

11. The system according to claim 10, wherein the circuitry is further configured to:
parse the recommendation output data generated by the generative neural network model to extract identification information referencing at least one of the selected candidate data records; and
execute a verification query against the storage device to confirm existence, availability, and condition conformity of each referenced candidate data record.

12. The system according to claim 11, wherein, when the verification query determines that a referenced candidate data record does not satisfy a constraint condition or is unavailable, the circuitry is further configured to:
discard the non-conforming candidate data record and select an alternative candidate data record from the ranked candidate lists; or
regenerate the second prompt sentence excluding the non-conforming candidate data record and re-input the regenerated second prompt sentence to the generative neural network model.

13. The system according to claim 12, wherein the circuitry is further configured to:
train an autoencoder neural network on historical suitability index distributions to establish a baseline reconstruction error, and detect an anomaly in a current suitability index distribution when a reconstruction error exceeds a predetermined threshold, the anomaly triggering a recalibration of weighting coefficients used in computing the suitability index.

14. The system according to claim 1, wherein the circuitry is further configured to:
receive, from the terminal device via the communication interface, evaluation data or feedback data indicating an assessment of the recommendation output data by the requesting entity; and
store the evaluation data or the feedback data in the storage device in association with the record data and the recommendation output data.

15. The system according to claim 14, wherein the circuitry is further configured to:
update at least one of a prompt sentence generation parameter and a candidate selection threshold based on aggregated feedback data from a plurality of requesting entities, the updating comprising adjusting similarity score thresholds and modifying weighting factors associated with state analysis dimensions in the suitability index computation.

16. The system according to claim 15, wherein the circuitry is further configured to:
compute performance indicators comprising an acceptance rate and an engagement duration for each prompt sentence template variant stored in the storage device; and
select, for subsequent prompt sentence generation, the prompt sentence template variant having a highest acceptance rate, thereby implementing a closed-loop behavioral feedback mechanism that updates generation conditions based on empirically measured interaction outcomes.

17. The system according to claim 1, wherein the state information obtained from the detection device comprises at least one of speech prosody features extracted from audio data, typing speed statistics, and facial expression features extracted from image data, and wherein the circuitry applies a classification model to the state information to output a categorical emotional state label and a confidence score.

18. A system comprising:
a communication interface coupled to a packet-switched network;
a storage device; and
circuitry configured to:
receive, via the communication interface, input data comprising a natural language request and attribute data associated with a requesting entity, and store the input data as record data in the storage device, the attribute data comprising capability descriptors and interest descriptors;
generate a first prompt sentence comprising the natural language request, the capability descriptors, and a constrained output format specification, and input the first prompt sentence to a generative neural network model to extract structured information comprising an intent classification, a target activity identifier, capability element identifiers, and interest element identifiers;
normalize the capability element identifiers and the interest element identifiers to canonical form using a normalization table, and generate a parameterized query command conditioned on the canonical identifiers to search entity profile data and classification-labeled reference data stored in the storage device;
compute a suitability index for each record returned by the search by evaluating a weighted combination of a capability match factor, an interest match factor, and a historical performance factor, and rank records in descending order of the suitability index to produce selected candidate data records;
analyze a state of the requesting entity based on the input data and state information obtained from a detection device to produce an emotional state label;
generate a second prompt sentence comprising at least the selected candidate data records with suitability index values, the attribute data, and the emotional state label, the second prompt sentence including an instruction specifying a tone and a level of detail conditioned on the emotional state label, and input the second prompt sentence to the generative neural network model to generate recommendation output data and an explanatory text;
extract identification information from the recommendation output data and execute a verification query against the storage device to confirm existence and availability of referenced records, and transmit verified recommendation output data and the explanatory text to a terminal device via the communication interface.

19. The system according to claim 18, wherein the circuitry is further configured to:
receive feedback data from the terminal device indicating an assessment of the verified recommendation output data, store the feedback data in the storage device, and update at least one of the normalization table, the weighted combination used in computing the suitability index, and a template used in generating the first prompt sentence or the second prompt sentence based on the feedback data.

20. A method comprising:
receiving, via a communication interface coupled to a packet-switched network, input data comprising a natural language request and attribute data associated with a requesting entity, and storing the input data as record data in a storage device;
generating, based on the natural language request and the attribute data, a first prompt sentence and inputting the first prompt sentence to a generative neural network model to extract structured information comprising an intent classification and capability element data associated with the requesting entity;
generating, based on activity content data and the capability element data included in the structured information, a query command for the storage device in which entity profile data and classification-labeled reference data are stored, and executing a search of the entity profile data and the classification-labeled reference data in accordance with the query command;
computing a suitability index by comparing the entity profile data and the classification-labeled reference data obtained by the search with the attribute data, and selecting candidate data records having a suitability index exceeding a threshold;
generating, based on the selected candidate data records, the suitability index, and the attribute data, a second prompt sentence and inputting the second prompt sentence to the generative neural network model to generate recommendation output data and an explanatory text;
transmitting the recommendation output data and the explanatory text to a terminal device via the communication interface; and
analyzing a state of the requesting entity based on the input data and state information obtained from a detection device, and including an analysis result in at least one of the first prompt sentence and the second prompt sentence.
